(19) United States
(12) Patent Application Publication
(10) Pub. No.: US 2026/0321730 A1
(43) Pub. Date: Oct. 15, 2026

(54) ELECTROLYTES FOR HIGH POWER RECHARGEABLE ELECTROCHEMICAL DEVICES, AND METHODS OF PRODUCING THE SAME

(71) Applicant: 24M Technologies, Inc., Cambridge, MA (US)

(72) Inventors: Junhua SONG, Sudbury, MA (US); Junzheng CHEN, Concord, MA (US); Humberto ROJAS, Roslindale, MA (US); Oliver HARRIS, Cambridge, MA (US); Frank Yongzhen FAN, Arlington, MA (US); Grace O'DWYER, Brighton, MA (US)

(21) Appl. No.: 19/281,317

(22) Filed: Jul. 25, 2025

Related U.S. Application Data
(60) Provisional application No. 63/762,324, filed on Feb. 24, 2025.

(51) Int. Cl. H01M 10/0569; H01M 10/0525; H01M 10/0567; H01M 10/0568

(52) U.S. Cl. CPC H01M 10/0569; H01M 10/0525; H01M 10/0567; H01M 10/0568; H01M 2300/0034; H01M 2300/004

(57) ABSTRACT

Systems, devices, and methods described herein relate to electrolyte formulations and the incorporation thereof into batteries. In some aspects, a composition can include between about 2 wt % and about 15 wt % of a fluoroether, a first electrolyte solvent, and a second electrolyte solvent different from the first electrolyte solvent. The composition can further include a first salt including hexafluorophosphate ions and a second salt different from the first salt. The first salt and the second salt collectively have a concentration between about 5 wt % and about 30 wt %. The composition further includes about 0.5 wt % to about 1.5 wt % of a first additive and about 0.5 wt % to about 1.5 wt % of a second additive, the second additive different from the first additive. In some embodiments, the composition can include between about 10 wt % and about 76 wt % of the first electrolyte solvent.

### CROSS-REFERENCE TO RELATED APPLICATIONS

The present application claims priority to and benefit of U.S. Provisional Application No. 63/762,324, filed Feb. 24, 2025, and entitled, “Electrolytes for High Power Rechargeable Electrochemical Devices, and Methods of Producing the Same,” the entire disclosure of which is hereby incorporated by reference herein.

### TECHNICAL FIELD

Embodiments described herein relate to electrolyte solutions for use in electrochemical cells such as batteries.

### BACKGROUND

The accelerated development of electrified transportation and aviation as well as a modernized grid with integrated renewable energy demands for high energy and high-power rechargeable batteries. A broad range of battery chemistries perform well, but their performance is hampered by low-conductivity electrolytes. The interactions between liquid molecules and electrolyte salts are very difficult to tune. An understanding of salt and solvent behavior at the molecular level can aid in production of batteries of many chemistries.

### SUMMARY

Systems, devices, and methods described herein relate to electrolyte formulations and the incorporation thereof into batteries. In some aspects, a composition can include between about 2 wt % and about 15 wt % of a fluoroether, a first electrolyte solvent, and a second electrolyte solvent different from the first electrolyte solvent. The composition can further include a first salt including hexafluorophosphate ions and a second salt different from the first salt. The first salt and the second salt collectively have a concentration in the composition between about 5 wt % and about 30 wt %. The composition further includes about 0.5 wt % to about 1.5 wt % of a first additive and about 0.5 wt % to about 1.5 wt % of a second additive, the second additive different from the first additive. In some embodiments, the composition can include between about 10 wt % and about 76 wt % of the first electrolyte solvent. In some embodiments, the composition can include between about 5 wt % and about 30 wt % of the second electrolyte solvent. In some embodiments, the composition can include between about 35 wt % and about 45 wt % of a third electrolyte solvent.

In some aspects, an electrochemical cell can include an anode, a cathode, a separator disposed between the anode and the cathode, and a liquid electrolyte. The liquid electrolyte can include a fluoroether, a first electrolyte solvent, a second electrolyte solvent different from the first electrolyte solvent, a first salt including hexafluorophosphate ions, a second salt different from the first salt, the first salt and the second salt collectively having a concentration between about 5 wt % and about 30 wt %, about 0.5 wt % to about 1.5 wt % of a first additive, and about 0.5 wt % to about 1.5 wt % of a second additive, the second additive different from the first additive.

In some aspects, a composition includes: about 10 wt % to about 30 wt % of a salt including hexafluorophosphate ions, about 40 wt % to about 60 wt % of a first electrolyte solvent, the first electrolyte solvent including methyl acetate; about 5 wt % to about 10 wt % of a second electrolyte solvent, the second electrolyte solvent different from the first electrolyte solvent; about 5 wt % to about 10 wt % of a third electrolyte solvent, the third electrolyte solvent different from the first electrolyte solvent and the second electrolyte solvent.

### BRIEF DESCRIPTION OF THE DRAWINGS

FIG. 1 is a block diagram of an electrolyte composition, according to an embodiment.

FIG. 2 is a block diagram of an electrochemical cell, according to an embodiment.

FIG. 3 is a graphical representation of voltage curves of electrochemical cells including electrolytes described herein.

FIG. 4 is a graphical representation of voltage curves and state of charge (SOC) curves of electrochemical cells including electrolytes described herein.

FIG. 5 is a graphical representation of voltage curves and cycling stability curves of electrochemical cells including electrolytes described herein.

FIG. 6 is a graphical representation of voltage curves and cycling stability curves of electrochemical cells including electrolytes described herein.

FIG. 7 is a graphical representation of voltage curves and cycling stability curves of electrochemical cells including electrolytes described herein.

FIG. 8 is a graphical representation of voltage curves and SOC curves of electrochemical cells including electrolytes described herein.

FIG. 9 is a graphical representation of voltage curves of electrochemical cells including electrolytes described herein.

FIG. 10 is a graphical representation of voltage curves and SOC curves of electrochemical cells including electrolytes described herein.

FIG. 11 is a graphical representation of voltage curves and cycling stability curves of electrochemical cells including electrolytes described herein.

FIG. 12 is a graphical representation of voltage curves and cycling stability curves of electrochemical cells including electrolytes described herein,

FIG. 13 is a graphical representation of voltage curves and capacity retention curves of electrochemical cells including electrolytes described herein.

FIG. 14 is a graphical representation of voltage curves and capacity retention rates of electrochemical cells including electrolytes described herein.

FIG. 15 is a graphical representation of voltage curves and capacity retention rates of electrochemical cells including electrolytes described herein.

FIG. 16 is a graphical representation of resistance vs. SOC curves of electrochemical cells including electrolytes described herein.

FIG. 17 is a graphical representation of capacity retention of electrochemical cells including electrolytes described herein.

FIG. 18 is a graphical representation of voltage curves and SOC curves of electrochemical cells including electrolytes described herein.

FIG. 19 is a graphical representation of voltage curves and cycling stability curves of electrochemical cells including electrolytes described herein.

FIG. 20 is a graphical representation of voltage curves and cycling stability curves of electrochemical cells including electrolytes described herein.

FIG. 21 is a graphical representation of voltage curves and cycling stability curves of electrochemical cells including electrolytes described herein.

FIG. 22 is a graphical representation of voltage curves and cycling stability curves of electrochemical cells including electrolytes described herein.

FIG. 23 is a graphical representation of voltage curves and cycling stability curves of electrochemical cells including electrolytes described herein.

FIG. 24 is a graphical representation of voltage curves and cycling stability curves of electrochemical cells including electrolytes described herein,

FIG. 25 is a graphical representation of voltage curves and cycling stability curves of electrochemical cells including electrolytes described herein.

FIG. 26 is a graphical representation of voltage curves of electrochemical cells including electrolytes described herein.

FIG. 27 is a graphical representation of voltage curves of electrochemical cells including electrolytes described herein.

FIG. 28 is a graphical representation of resistance curves and max pulse C-rate curves of electrochemical cells including electrolytes described herein.

FIG. 29 is a graphical representation of cycling stability and cycling voltage profile curves of electrochemical cells including a conventional electrolyte.

FIG. 30 is a graphical representation of voltage curves of electrochemical cells including electrolytes described herein.

FIG. 31 is a graphical representation of cycling stability and cycling voltage profile curves of electrochemical cells including a conventional electrolyte.

FIG. 32 is a graphical representation of cycling stability and cycling voltage profile curves of electrochemical cells including a conventional electrolyte.

FIGS. 33A-33B show exemplary solvation structures.

### DETAILED DESCRIPTION

High-capacity anodes have been used at increasing rates to increase the energy density of lithium ion batteries or other battery chemistries. However, the improvement of energy density is met with challenges in delivering high charge/discharge power without compromising cycling stability and cell safety. High-capacity anode materials can include a blend of intercalation-based carbonaceous materials and alloy-based materials. In some cases, anodes with pure alloy-based materials can be used to maximize energy output. However, anodes with high energy capacity can quickly lose that capacity through successive cycles due to volume change upon lithium alloying and/or dealloying. Remedies to this capacity loss can include materials engineering, electrolyte formulation, electrode fabrication, and/or cell design. Electrolyte composition can play an important role in dictating cell performance, but receives less attention in the current state of the art, due to the near exhaustion of formulations with classical solvents and/or salts. An electrolyte formulation with innovative chemical blends can unlock the potential of a high energy anode.

Electrolytes described herein can be used with a broad range of electrochemical cell chemistries. In some embodiments, electrolytes described herein can be incorporated into lithium cobalt oxide batteries, lithium nickel manganese cobalt oxide batteries, lithium nickel cobalt aluminum oxide batteries, lithium manganese oxide batteries, lithium cobalt phosphate batteries, lithium nickel phosphate batteries, lithium iron phosphate batteries, lithium manganese phosphate batteries, lithium manganese iron phosphate batteries, lithium titanate batteries, magnesium-based batteries, zinc-ion batteries, zinc manganese oxide batteries, etc.

Conventional liquid electrolytes also have several drawbacks. They have an unstable interphase with lithium metal, leading to dendrite formation and electrolyte consumption. They can have poor cycle life, poor power performance, poor fast charge performance, poor low temperature performance, and can be flammable. Further, conventional liquid electrolytes have poor processibility due to volatility.

Advanced liquid electrolytes (e.g., highly concentrated electrolytes (HCE) and localized highly concentrated electrolytes (LHCE)) have low ionic conductivity and therefore poor power performance. Poor separator and electrode wetting are issues for HCE. Advanced liquid electrolytes are also expensive. LHCE are consumed quickly due to the presence of fluorinated diluents. They also exhibit moderate to poor fast charge capabilities due to high interfacial impedance. Poor processibility is also an issue due to the volatility of the LHCE. Advanced liquid electrolytes also perform poorly at low temperatures.

In conventional lithium ion electrolytes, a small, highly charged Li⁺ ion generates a strong electric field that attracts the partial negative charge of oxygen atoms of solvent molecules. A few solvent molecules (e.g., about 4 to about 6) coordinate around the Li⁺ ion to form a stabilizing solvation shell. This solvation enables the lithium ion to move efficiently through the electrolyte. This ion movement can occur via several mechanisms. First, in a vehicular transport mechanism, Li⁺ ions move while solvated by solvent molecules. This is a common mechanism in liquid electrolytes. Second in an ion hopping mechanism, Li⁺ ions jump between coordination sites. This mechanism is common in solid-state electrolytes. Third, in a diffusion mechanism, Li⁺ ions move from high concentration regions to low concentration regions, driven by concentration gradients.

The vehicular transport mechanism is the most common in commercial electrolytes with dilute lithium salt concentrations (e.g., 1M LiPF₆). However, the transference number (i.e., the fraction of the total ionic current carried by the Li⁺ ions in the electrolyte under an electric field) in the vehicular transport mechanism is low (i.e., often in the range of 0.2-0.4). The ion hopping mechanism often appears in a high concentration electrolyte and refers to a mechanism where Li ions move by jumping between transient coordination sites formed by nearby anions or solvent molecules. Such a mechanism is facilitated by strong ion-ion and ion-solvent interactions due to high salt concentrations. This type of electrolyte often has low conductivity but a high transference number (e.g., at least about 0.5).

Systems and methods commonly used to improve ionic conductivity include: (1) high dielectric constant solvents that promote more complete lithium salt dissociation; (2) lower solvent viscosity; and (3) adjustment of lithium salt concentration (e.g., higher concentration for higher transference number). However, neither of these methods have significantly improved electrolyte performance. A new electrolyte design or formulation can improve conductivity of electrolytes.

Developing an electrolyte that can address the aforementioned challenges and meet all performance expectations (e.g., energy density, cycle life, power, fast charge, low temperature, safety, stable interphase, etc.) can greatly improve cell performance. Such an electrolyte that fits within existing manufacturing infrastructure would provide additional convenience in implementation.

Electrolytes described herein may provide significant performance-based characteristics and advantages over conventional electrolyte, which can significantly enhance the performance, including, for example: (1) providing high conductivities, for example, greater than 10 mS/cm; (2) enabling 10C fast charge of graphite or other intercalation-based charges with at least about 97% capacity retention (vs. conventional cells (i.e., Gr-NMC and Gr/Si-NMC systems with carbonate-based electrolyte) charging at less than 3C); (3) enabling 10C fast charge of silicon or other alloy-based charges with at least about 97% capacity retention (vs. conventional cells charging at less than 3C); (4) enabling at least about 90% capacity retention at −20° C. (vs. conventional cells with 94% a 0° C.). Electrolytes described herein can enable about 100% capacity retention with 5C charge/1C discharge over 200 cycles (vs. conventional cells with about 95%); and (5) flexibility of providing enhanced performance in various cell chemistries; and (6) allowing easily drop in replacement as the electrolyte in conventional cells using conventional electrolytes.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes.

In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrochemical cells described herein can include conventional electrodes, for example, electrodes including binders.

In some embodiments, the electrode materials described herein can include a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid electrodes are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L), including the electrodes, the separator, the electrolyte, the current collectors, and cell packaging. Unless otherwise noted, energy density and volumetric density include cell packaging,

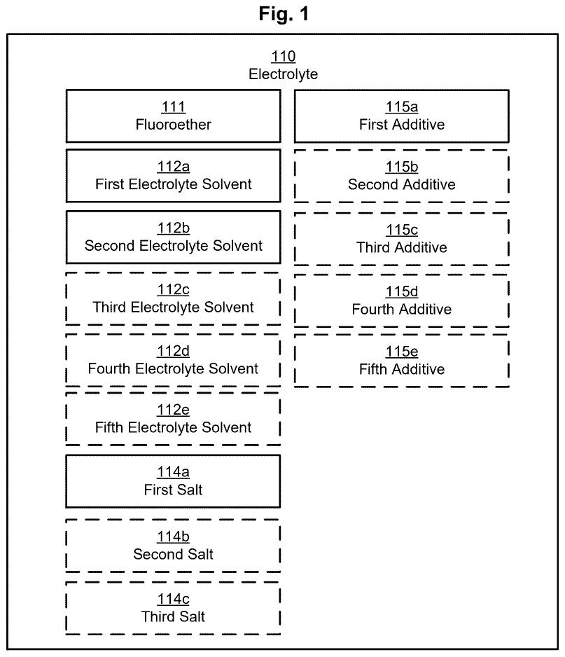

FIG. 1 is a block diagram of a composition of an electrolyte 110, according to an embodiment. As shown, the electrolyte 110 can include a fluoroether (FE) 111, a first electrolyte solvent 112a, a second electrolyte solvent 112b, an optional third electrolyte solvent 112c, an optional fourth electrolyte solvent 112d, an optional fifth electrolyte solvent 112e, a first salt 114a, an optional second salt 114b, an optional third salt 114c, a first additive 115a, an optional second additive 115b, an optional third additive 115c, an optional fourth additive 115d, and an optional fifth additive 115e.

In some embodiments, the FE 111 can include bis(2-fluoroethyl) ether (BFE). In some embodiments, the FE 111 can have the following structure:

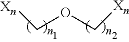

Where n₁ and n₂ can each have values between 1 and 5, X=F, Br, Cl, or, n=1, 2, or 3 per molecule. In other words, the FE 111 can be replaced with an ether that has includes other halogens in place of the fluorine atoms. In some embodiments, X=F.

The molecular structure of the FE 11I has an effect on solvent properties and interactions with a co-solvent. Considering the following examples:
A: X=H, n=3;
B: X=F, n=1;
C: X=F, n=2;
D: X=F, n=3.

The properties of the molecules are affected by these structures. For boiling point, B>C>D>A, and the structure has a strong effect. For dipole-dipole interaction, B>C>D>A, and the structure has a strong effect. For atypical hydrogen bonding, B>C>D>A, and the structure has a strong effect. For London Dispersion force, D>C>B>A, and the structure has a weak effect. For steric hinderance, D>C>B>A.

In some embodiments, n₁ and/or n₂ can be 1, 2, 3, 4, or 5. In some embodiments, n can be 1, 2, 3, 4, or 5. The FE 111 can act as a solvent, in that the FE 111 solvates at least a portion of the first salt 114a, the second salt 114b, and/or the third salt 114c. In other words, the FE 111 is not used as a diluent or a precipitation facilitation medium. In some embodiments, the FE 111 can include a terminal carbon atom that is not fully saturated with halogen atoms. In some embodiments, the FE 111 can include terminal carbon atoms with a single halogen atom bonded thereto. In some embodiments, the FE 111 is not a hydrofluoroether. In some embodiments, the FE 111 can have the following structure.

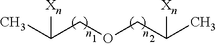

where n₁ and n₂ can each have values between 0 and 5, X=F, Br, Cl, or I, n=1-2 per molecule. In other words, the FE 111 can be replaced with an ether that has includes other halogens in place of the fluorine atoms. In some embodiments, X=F.

In some embodiments, the FE 111 can make up at least about 1 wt, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, at least about 29 wt %, at least about 30 wt %, at least about: 3 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 4 wt %, at least about 42 wt %, at least about 43 wt %, at least about 44 wt %, at least about 45 wt %, at least about 46 wt %, at least about 47 wt %, at least about 48 wt %, at least about 49 wt %, at least about 50 wt %, at least about 51 wt %, at least about 52 wt %, at least about 53 wt %, at least about 54 wt, at least about 55 wt %, at least about 56 wt %, at least about 57 wt %, at least about 58 wt %, or at least about 59 wt % of the electrolyte 110.

In some embodiments, the FE 111 can make up no more than about 60 wt %, no more than about 59 wt %, no more than about 58 wt %, no more than about 57 wt %, no more than about 56 wt %, no more than about 55 wt %, no more than about 54 wt %, no more than about 53 wt %, no more than about 52 wt %, no more than about 51 wt %, no more than about 50 wt %, no more than about 49 wt %, no more than about 48 wt %, no more than about 47 wt %, no more than about 46 no more than about 45 wt %, no more than about 44 wt %, no more than about 43 wt % no more than about 42 wt %, no more than about 41 wt %, no more than about 40 wt %, no more than about 39 wt %, no more than about 38 wt, no more than about 37 wt %, no more than about 36 wt % no more than about 35 wt %, no more than about 34 wt %, no more than about 33 wt %, no more than about 32 wt %, no more than about 31 wt %, no more than about 30 wt %, no more than about 2 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt % or no more than about 2 wt % of the electrolyte 110.

Combinations of the above-referenced weight percentages are also possible (e.g., at least about 1 wt % and no more than about 59 wt % or at least about 18 wt % and no more than about 36 wt %) inclusive of all values and ranges therebetween. In some embodiments, the FE 111 can make up about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt % about 22 wt %, about 23 wt %, about 24 wt %, about 25 wt %, about 26 wt %, about 27 wt about 28 wt %, about 29 wt %, about 30 wt %, about 31 wt %, about 32 wt %, about 33 wt %, about 34 wt %, about 35 wt %, about 36 wt %, about 37 wt, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt about 54 wt %, about 55 wt %, about 56 wt %, about 57 wt %, about 58 wt %, or about 59 wt % of the electrolyte 110.

The percentage of the FE 111 in the electrolyte 110 can vary based on the battery chemistry of an electrochemical cell that includes the electrolyte 110. For example, in a zinc-based chemistry, the composition of the FE 111 can be much lower than in a lithium metal battery.

In some embodiments, the first electrolyte solvent 112a can function as a primary salt dissociation solvent and/or a fire retardant. In some embodiments, the first electrolyte solvent 112a can include a polar solvent. In some embodiments, the first electrolyte solvent 112a can include at least one of 1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, γ-butyrolactone, tetrahydropyranyl, 4-vinyl-1,3-dioxolane-2-one, dimethyl sulfone, methyl butyrate, ethyl propiolate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, or fluoroethylene carbonate.

In some embodiments, the first electrolyte solvent 112a can include a non-polar solvent (e.g., a non-polar co-solvent). In some embodiments, the first electrolyte solvent 112a can include at least one of fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoromethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether 1,1,2,2,-tetrafluoroethyl-22,22-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, or 3,3,4,4,5,5-hexafluorotetrahphydropyran.

In some embodiments, the first electrolyte solvent 412a can make up at least about 10 wt at least about 11 wt %, at least about 12 wt %, at least about 13 wt at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt % at least about 49 wt %, at least about 50 wt %, at least about 51 wt %, at least about 52 wt %, at least about 53 wt %, at least about 54 wt %, at least about 55 wt %, at least about 56 wt %, at least about 57 wt %, at least about 58 wt %, at least about 59 wt %, at least about 60 wt %, at least about 61 wt %, at least about 62 wt %, at least about 63 wt %, at least about 64 wt %, at least about 65 wt %, at least about 66 wt %, at least about 67 wt %, at least about 68 wt %, at least about 69 wt %, at least about 70 wt %, at least about 71 wt %, at least about 72 wt %, at least about 73 wt %, at least about 71 wt %, or at least about 75 wt % of the electrolyte 110.

In some embodiments, the first electrolyte solvent 112a can make up no more than about 76 wt %, no more than about 75 wt %, no more than about 74 wt %, no more than about 73 wt %, no more than about 72 wt %, no more than about 71 wt %, no more than about 70 wt %, no more than about 69 wt %, no more than about 68 wt %, no more than about 67 wt %, no more than about 66 wt %, no more than about 65 wt %, no more than about 64 wt %, no more than about 63 wt %, no more than about 62 wt %, no more than about 61 wt %, no more than about 60 wt %, no more than about 59 wt %, no more than about 58 wt %, no more than about 57 wt %, no more than about 56 wt %, no more than about 55 wt %, no more than about 54 wt %, no more than about 53 wt %, no more than about 52 wt %, no more than about 51 wt %, no more than about 50 wt %, no more than about 49 wt %, no more than about 48 wt %, no more than about 47 wt %, no more than about 46 wt %, no more than about 45 wt %, no more than about 44 wt %, no more than about 43 wt %, no more than about 42 wt %, no more than about 41 wt %, no more than about 40 wt %, no more than about 39 wt %, no more than about 38 wt %, no more than about 37 wt %, no more than about 36 wt %, no more than about 35 wt %, no more than about 34 wt %, no more than about 33 wt %, no more than about 32 wt %, no more than about 31 wt %, no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, or no more than about 10 wt % of the electrolyte 110.

Combinations of the above-referenced weight percentages are also possible (e.g., at least about 10 wt % and no more than about 76 wt % or at least about 13 wt % and no more than about 39 wt %), inclusive of all values and ranges therebetween. In some embodiments, the first electrolyte solvent 112a can make up about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56%, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, or about 76 wt % of the electrolyte 110.

In some embodiments, the second electrolyte solvent 112b can be different from the first electrolyte solvent 112a. In some embodiments, the second electrolyte solvent 112b can function as a primary film former and secondary salt dissociation solvent. In some embodiments, the second electrolyte solvent 112b can include a polar solvent. In some embodiments, the second electrolyte solvent 112b can include at least one of 1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, γ-butyrolactone, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, or fluoroethylene carbonate.

In some embodiments, the second electrolyte solvent 112b can include a non-polar solvent. In some embodiments, the second electrolyte solvent 112b can include fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, and/or 3,3,4,4,5,5-hexafluorotetrahphydropyran.

In some embodiments, the second electrolyte solvent 112b can make up at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt % of the electrolyte 110. In some embodiments, the second electrolyte solvent 112b can make up no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, or no more than about 4 wt % of the electrolyte 110. Combinations of the above-referenced weight percentages are also possible (e.g., at least about 3 wt % and no more than about 30 wt % or at least about 13 wt % and no more than about 25 wt %), inclusive of all values and ranges therebetween. In some embodiments, the second electrolyte solvent 112b can make up about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the electrolyte 110.

In some embodiments, the third electrolyte solvent 112c can be different from the first electrolyte solvent 112a and the second electrolyte solvent 112b In some embodiments, the third electrolyte solvent 112c can function as a primary ion transport enhancer, an oxidation stability enhancer, a wetting enhancer, a thermal stability enhancer, a secondary film former, and/or a secondary salt dissociation constant. In some embodiments, the third electrolyte solvent 112c can include a polar solvent. In some embodiments, the third electrolyte solvent 112c can include at least one of 1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, 7-butyrolactone, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, or fluoroethylene carbonate.

In some embodiments, the third electrolyte solvent 112c can include a non-polar solvent. In some embodiments, the third electrolyte solvent 112c can include at least one of fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, or 3,3,4,4,5,5-hexafluorotetrahphydropyran.

In some embodiments, the third electrolyte solvent 112c can make up at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt % of the electrolyte 110. In some embodiments, the third electrolyte solvent 112c can make up no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, or no more than about 4 wt % of the electrolyte 110. Combinations of the above-referenced weight percentages are also possible (e.g., at least about 3 wt % and no more than about 30 wt % or at least about 13 wt % and no more than about 25 wt %), inclusive of all values and ranges therebetween. In some embodiments, the third electrolyte solvent 112c can make up about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the electrolyte 110.

In some embodiments, the fourth electrolyte solvent 112d can be different from the first electrolyte solvent 112a, the second electrolyte solvent 112b, and the third electrolyte solvent 112c. In some embodiments, the fourth electrolyte solvent 112d can include a polar solvent. In some embodiments, the fourth electrolyte solvent 112d can include at least one of 1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, γ-butyrolactone, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, or fluoroethylene carbonate.

In some embodiments, the fourth electrolyte solvent 112d can include a non-polar solvent. In some embodiments, the fourth electrolyte solvent 112d can include at least one of fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, or 3,3,4,4,5,5-hexafluorotetrahphydropyran.

In some embodiments, the fourth electrolyte solvent 112d can make up at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt % of the electrolyte 110 in some embodiments, the fourth electrolyte solvent 112d can make up no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt/%, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, or no more than about 4 wt % of the electrolyte 110. Combinations of the above-referenced weight percentages are also possible (e.g., at least about 3 wt % and no more than about 30 wt % or at least about 13 wt % and no more than about 25 wt %), inclusive of all values and ranges therebetween. In some embodiments, the fourth electrolyte solvent 112d can make up about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the electrolyte 110.

In some embodiments, the fifth electrolyte solvent 112e can be different from the first electrolyte solvent 112a, the second electrolyte solvent 112b, the third electrolyte solvent 112c, and the fourth electrolyte solvent 112d. In some embodiments, the fifth electrolyte solvent 1l2e can include a polar solvent. In some embodiments, the fifth electrolyte solvent 112e can include at least one of 1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, γ-butyrolactone, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, or fluoroethylene carbonate.

In some embodiments, the fifth electrolyte solvent 112e can include a non-polar solvent. In some embodiments, the fifth electrolyte solvent 112e can include at least one of fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, or 3,3,4,4,5,5-hexafluorotetrahphydropyran.

In some embodiments, the fifth electrolyte solvent 112e can make up at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt % of the electrolyte 110. In some embodiments, the fifth electrolyte solvent 112e can make up no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, or no more than about 6 wt %, no more than about 5 wt %, or no more than about 4 wt % of the electrolyte 110. Combinations of the above-referenced weight percentages are also possible (e.g., at least about 5 wt % and no more than about 30 wt % or at least about 13 wt % and no more than about 25 wt %), inclusive of all values and ranges therebetween. In some embodiments, the fifth electrolyte solvent 112e can make up about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the electrolyte 110.

in some embodiments, the first electrolyte solvent 112a, the second electrolyte solvent 112b, the third electrolyte solvent 112c, the fourth electrolyte solvent 112d, and/or the fifth electrolyte solvent 112e can include a fire retardant. In some embodiments, the first electrolyte solvent 112a, the second electrolyte solvent 112b, the third electrolyte solvent 112c, the fourth electrolyte solvent 112d, and/or the fifth electrolyte solvent 112e can include tributyl phosphate, triphenyl phosphate, tris(2,2,2-trifluoroethyl) phosphate, bis(2,2,2-trifluoroethyl) methyl phosphate, trimethyl phosphite, triphenyl phosphite, tris(2,2,2-trifluoroethyl) phosphite, dimethyl methylphosphonate, diethyl ethylphosphonate, diethyl phenylphosphonate, 2-(2,2,2-trifluoroethoxy)-1,3,2-dioxaphospholane 2-oxide, bis(2,2,2-trifluoroethyl) methylphosphonate, hexamethylphosphoramide, hexamethoxyphosphazene (cyclo-tris(dimethoxyphosphonitrile), hexamethoxycyclotriphosphazene), hexafluorophosphazene (hexafluorocyclotriphosphazene), or any combination thereof.

In some embodiments, the first electrolyte solvent 112a, the second electrolyte solvent 112b, the third electrolyte solvent 112c, the fourth electrolyte solvent 112d, and/or the fifth electrolyte solvent 112e can exhibit hydrogen bonding. In some embodiments, the hydrogen bonding can be between solvents (e.g., between the first electrolyte solvent and the second electrolyte solvent 112b). In some embodiments, the hydrogen bonding can be between solvent and salt (e.g., between the first electrolyte solvent 111a and the first salt 114a). In some embodiments, the hydrogen bonds can have a bond strength of at least about 10 kJ/mol, at least about 20 kJ/mol, at least about 30 kJ/mol, at least about 40 kJ/mol, at least about 50 kJ/mol, at least about 60 kJ/mol, at least about 70 kJ/mol, at least about 80 kJ/mol, at least about 90 kJ/mol, at least about 100 kJ/mol, at least about 110 kJ/mol, at least about 120 kJ/mol, at least about 130 kJ/mol, at least about 140 kJ/mol, at least about 150 kJ/mol, at least about 160 kJ/mol, at least about 170 kJ/mol, at least about 180 kJ/mol, or at least about 190 kJ/mol. In some embodiments, the hydrogen bonds can have a bond strength of no more than about 200 kJ/mol, no more than about 190 kJ/mol, no more than about 180 kJ/mol, no more than about 170 kJ/mol, no more than about 160 kJ/mol, no more than about 150 kJ/mol, no more than about 140 kJ/mol, no more than about 130 kJ/mol, no more than about 120 kJ/mol, no more than about 110 kJ/mol, no more than about 100 kJ/mol, no more than about 90 kJ/mol, no more than about 80 k/mol, no more than about 70 kJ/mol, no more than about 60 kJ/mol, no more than about 50 kJ/mol, no more than about 40 kJ/mol, no more than about 30 kJ/mol, or no more than about 20 kJ/mol. Combinations of the above-referenced bond strengths are also possible (e.g., at least about 10 kJ/mol and no more than about 200 kJ/mol or at least about 40 kJ/mol and no more than about 150 kJ/mol), inclusive of all values and ranges therebetween. In some embodiments, the hydrogen bonds can have a bond strength of about 10 kJ/mol, about 20 kJ/mol, about 30 kJ/mol, about 40 kJ/mol, about 50 kJ/mol, about 60 kJ/mol, about 70 kJ/mol, about 80 kJ/mol, about 90 kJ/mol, about 100 kJ/mol, about 110 kJ/mol, about 120 kJ/mol, about 130 kJ/mol, about 140 kJ/mol, about 150 kJ/mol, about 160 kJ/mol, about 170 kJ/mol, about 180 kJ/mol, about 190 kJ/mol, or about 200 kJ/mol.

Table 1 shows exemplary bonding configurations for possible donor-acceptor pairs in a hydrogen bonding scheme.

TABLE 1
Exemplary Bonding Configurations for Hydrogen Bonding

| | Acceptor |
|---|---|
| Donor Group | Group |
| O—H•••O | Alcohols, |
| | water |
| O—H•••N | Alcohols to |
| | amines |
| N—H•••O | Amides to |
| | carbonyls |
| N—H•••N | Amines to |
| | amines |
| F—H•••O/N | HF to |
| | carbonyls or |
| | amines |
| C—H•••O/N | Weak donors |
| S—H•••O/N | Thiols to |
| | carbonyls or |
| | amines |
| F•••H—X | Fluorine as |
| | acceptor |
| Cl•••H—X | Chlorine as |
| | acceptor |
| Br•••H—X | Bromine as |
| | acceptor |
| I•••H—X | Iodine as |
| | acceptor |

Some embodiments described herein exhibit common hydrogen bonding patterns—i.e., a hydrogen atom bonded to a highly electronegative atom (e.g., N, O, F) acting as a hydrogen bond donor, and another electronegative atom with a lone pair acting as a hydrogen bond acceptor (e.g., water O—H···O). Some embodiments described herein can exhibit atypical hydrogen bonding—i.e., a hydrogen or halogen atom bonded to moderate, weak, or non-electronegative atoms like carbon or hydrogen (e.g., C—H···O, C—F···H). For example, if X=F, Br, Cl, or I at the end of a chain can serve as an acceptor. Hydrogen atoms from the co-solvents can serve as the donor In some embodiments, the oxygen atom at or near the center of the FE 111 and/or on the co-solvents can serve as a hydrogen acceptor, while the hydrogen atom from the co-solvents can serve as the donor. In some embodiments, the nitrogen atoms of the co-solvents can serve as the acceptor while the hydrogen atoms of the co-solvents can serve as the donor. In some embodiments, the oxygen atom at or near the center of the FE 111 and/or on the co-solvents can serve as the acceptor while a hydrogen atom from the co-solvents serves as a donor. In some embodiments, the hydrogen atom of the co-solvents can serve as a donor while the X atom (F, Br, Cl, I) from the co-solvents serves as the acceptor. In some embodiments, the hydrogen atoms from the co-solvents can serve as the donor, while the oxygen atoms of the FE 111 and/or the co-solvents can serve as the acceptor. In some embodiments, the hydrogen atoms of the FE 111 and/or the co-solvents can serve as the donor while the nitrogen atoms of the co-solvents can serve as an acceptor.

In some embodiments, the combination of the first electrolyte solvent 112a, the second electrolyte solvent 112b, the third electrolyte solvent 112c, the fourth electrolyte solvent 112d, and/or the fifth electrolyte solvent 112e and any salts included therein can reduce the activation energy for ion hopping. In some embodiments, the activation energy for ion hopping in the electrolyte 110 can be no more than about 100 kJ/mol, no more than about 95 kJ/mol, no more than about 90 kJ/mol, no more than about 85 kJ/mol, no more than about 80 kJ/mol, no more than about 75 kJ/mol, no more than about 70 k/mol, no more than about 65 kJ/mol, no more than about 60 kJ/mol, no more than about 55 kJ/mol, no more than about 50 kJ/mol, no more than about 45 kJ/mol, no more than about 40 kJ/mol, no more than about 35 kJ/mol, or no more than about 30 kJ/mol, inclusive of all values and ranges therebetween.

In some embodiments, the Li—Oₐₙᵢₒₙ bond occupies at least about 5%, at least about 10%, at least about 15%, at least about 20%, or at least about 25% of the first solvation sheath. In some embodiments, the Li-Oₐₙᵢₒₙ bond occupies no more than about 30%, no more than about 25%, no more than about 20%, no more than about 15%, or no more than about 10% of the first solvation sheath. Combinations of the above-referenced percentages are also possible (e.g., at least about 5% and no more than about 30% or at least about 10% and no more than about 20%), inclusive of all values and ranges therebetween. In some embodiments, the Li—Oₐₙᵢₒₙ bond occupies about 5%, about 10%, about 15%, about 20%, about 25%, or about 30% of the first solvation sheath

In some embodiments, the Li—X (X=F, Br, Cl, I) bond occupies at least about 5%, at least about 10%, at least about 15%, at least about 20%, at least about 25%, at least about 30%, at least about 35%, at least about 40%, at least about 45%, at least about 50%, or at least about 55% of the first solvation sheath. In some embodiments, the Li—X bond occupies no more than about 60%, no more than about 55%, no more than about 50%, no more than about 45%, no more than about 40%, no more than about 35%, no more than about 30%, no more than about 25%, no more than about 20%, no more than about 15%, or no more than about 10% of the first solvation sheath. Combinations of the above-referenced percentages are also possible (e.g., at least about 5% and no more than about 60% or at least about 20% and no more than about 40%), inclusive of all values and ranges therebetween. In some embodiments, the Li—X bond occupies about 5%, about 10%, about 15%, about 20%, about 25%, about 30%, about 35%, about 40%, about 45%, about 50%, about 55%, or about 60% of the first solvation sheath.

In some embodiments, the bond distance between Li⁺ ions and the solvation shell (i.e., the solvation distance) in the electrolyte 110 can be at least about 0.15 nm, at least about 0.16 nm, at least about 0.17 nm, at least about 0.18 nm, at least about 0.19 nm, at least about 0.2 nm, at least about 0.21 nm, at least about 0.22 nm, at least about 0.23 nm, or at least about 0.24 nm. In some embodiments, the solvation distance in the electrolyte 110 can be no more than about 0.25 nm, no more than about 0.24 nm, no more than about 0.23 nm, no more than about 0.22 nm, no more than about 0.21 nm, no more than about 0.2 nm, no more than about 0.19 nm, no more than about 0.18 nm, no more than about 0.17 nm, or no more than about 0.16 nm. Combinations of the above-referenced solvation distances are also possible (e.g., at least about 0.15 nm and no more than about 0.25 nm or at least about 0.18 nm and no more than about 0.22 nm), inclusive of all values and ranges therebetween. In some embodiments, the solvation distance in the electrolyte 110 can be about 0.15 nm, about 0.16 nm, about 0.17 nm, about 0.18 nm, about 0.19 nm, about 0.2 nm, about 0.21 nm, about 0.22 nm, about 0.23 nm, about 0.24, or about 0.25 nm.

In some embodiments, the first electrolyte solvent 112a, the second electrolyte solvent 112b, the third electrolyte solvent 112c, the fourth electrolyte solvent 112d, and/or the fifth electrolyte solvent 112e can have a molar mass of no more than about 100 g/mol, no more than about 95 g/mol, no more than about 90 g/mol, no more than about 85 g/mol, no more than about 80 g/mol, no more than about 75 g/mol, no more than about 70 g/mol, no more than about 65 g/mol, no more than about 60 g/mol, no more than about 55 g/mol, no more than about 50 g/mol, no more than about 45 g/mol, no more than about 40 g/mol, no more than about 35 g/mol, no more than about 30 g/mol, no more than about 25 g/mol, or no more than about 20 g/mol, inclusive of all values and ranges therebetween.

In some embodiments, the first electrolyte solvent 112a, the second electrolyte solvent 112b, the third electrolyte solvent 112c, the fourth electrolyte solvent 112d, and/or the fifth electrolyte solvent 112e can have an intermedia dielectric constant (i.e., a dielectric constant between solvents) of at least about 50 (at standard temperature and pressure), at least about 55, at least about 60, at least about 65, at least about 70, at least about 75, at least about 80, at least about 85, at least about 90, at least about 95, at least about 100, at least about 105, at least about 110, at least about 115, at least about 120, at least about 125, at least about 130, at least about 135, at least about 140, or at least about 145. In some embodiments, the first electrolyte solvent 112a, the second electrolyte solvent 112b, the third electrolyte solvent 112c, the fourth electrolyte solvent 112d, and/or the fifth electrolyte solvent 112e can have an intermedia dielectric constant of no more than about 150, no more than about 145, no more than about 140, no more than about 135, no more than about 130, no more than about 125, no more than about 120, no more than about 115, no more than about 110, no more than about 105, no more than about 100, no more than about 95, no more than about 90, no more than about 85, no more than about 80, no more than about 75, no more than about 70, no more than about 65, no more than about 60, or no more than about 55. Combinations of the above-referenced dielectric constants are also possible (e.g., at least about 50 and no more than 150 or at least about 60 and no more than about 120), inclusive of all values and ranges therebetween. In some embodiments, the first electrolyte solvent 112a, the second electrolyte solvent 112b, the third electrolyte solvent 112c, the fourth electrolyte solvent 112d, and/or the fifth electrolyte solvent 112e can have an intermedia dielectric constant of about 50, about 55, about 60, about 65, about 70, about 75, about 80, about 85, about 90, about 95, about 100, about 105, about 110, about 115, about 120, about 125, about 130, about 135, about 140, about 145, or about 150.

In some embodiments, the electrolyte 110 can have a viscosity (at 20° C.) of no more than about 1.5 mPa·s, no more than about 1.4 mPa·s, no more than about 1.3 mPa·s, no more than about 1.2 mPa·s, no more than about 1.1 mPa·s, no more than about 1 mPa·s, no more than about 0.9 mPa·s, no more than about 0.8 mPa·s, no more than about 0.7 mPa·s, no more than about 0.6 mPa·s, or no more than about 0.5 mPa·s, inclusive of all values and ranges therebetween.

In some embodiments, the first electrolyte solvent 112a, the second electrolyte solvent 112b, the third electrolyte solvent 112c, the fourth electrolyte solvent 112d, and/or the fifth electrolyte solvent 112e can have energetically favorable interactions with one another (e.g., <0 kJ/mol). In some embodiments, the first electrolyte solvent 112a, the second electrolyte solvent 112b, the third electrolyte solvent 112c, the fourth electrolyte solvent 112d, and/or the fifth electrolyte solvent 112e can have an interaction energy (i.e., the contribution of the interaction of two or more solvents to the total energy of the system) of less than about −10 kJ/mol, less than about −15 kJ/mol, less than about −20 kJ/mol, less than about −25 kJ/mol, less than about −30 kJ/mol, or less than about −35 kJ/mol. In some embodiments, the first electrolyte solvent 112a, the second electrolyte solvent 112b, the third electrolyte solvent 112c, the fourth electrolyte solvent 112d, and/or the fifth electrolyte solvent 112e can have an interaction energy of greater than about −40 kJ/mol, greater than about −35 k/mol, greater than about −30 k/mol, greater than about −25 k/mol, greater than about −20 kJ/mol, or greater than about −15 kJ/mol. Combinations of the above-referenced interaction energies are also possible (e.g., less than about −10 kJ/mol and greater than about −40 kJ/mol or less than about −20 kJ/mol and greater than about −30 kJ/mol. In some embodiments, the first electrolyte solvent 112a, the second electrolyte solvent 112b, the third electrolyte solvent 112c, the fourth electrolyte solvent 112d, and/or the fifth electrolyte solvent 112e can have an interaction energy of about −10 kJ/mol, about −15 kJ/mol, about −20 kJ/mol, about −25 kJ/mol, about −30 kJ/mol, about −35 kJ/mol, or about 40 kJ/mol. In some embodiments, interaction energy can be measured via the supermolecular approach. In some embodiments, interaction energy can be measured via molecular dynamics (MD) simulation, density functional theory (DFT) simulation, vapor pressure and enthalpy of vaporization, Fourier Transform Infrared (FTIR), Raman spectroscopy, or any combination thereof.

In some embodiments, the solvation energy (i.e., the energy change associated with dissolving ions in solvent) between the Li⁺ ions and at least one of the first electrolyte solvent 112a, the second electrolyte solvent 112b, the third electrolyte solvent 112c, the fourth electrolyte solvent 112d, or the fifth electrolyte solvent 112e can be less than about −40 kJ/mol, less than about −50 kJ/mol, less than about −60 kJ/mol, less than about −70 kJ/mol, less than about −80 kJ/mol, less than about −90 kJ/mol, less than about −100 kJ/mol, less than about −110 kJ/mol, less than about −120 kJ/mol, less than about −130 kJ/mol, less than about −140 kJ/mol, or less than about −150 kJ/mol. In some embodiments, the solvation energy between the Li⁺ ions and at least one of the first electrolyte solvent 112a, the second electrolyte solvent 112b, the third electrolyte solvent 112c, the fourth electrolyte solvent 112d, or the fifth electrolyte solvent 112e can be greater than about −160 kJ/mol, greater than about −150 kJ/mol, greater than about −140 kJ/mol, greater than about −130 kJ/mol, greater than about −120 kJ/mol, greater than about −110 kJ/mol, greater than about −100 kJ/mol, greater than about −90 kJ/mol, greater than about −80 kJ/mol, greater than about −70 kJ/mol, greater than about −60 kJ/mol, or greater than about −50 kJ/mol. Combinations of the above-referenced solvation energies are also possible (e.g., less than about −40 kJ/mol and greater than about −160 kJ/mol or less than about −60 kJ/mol and greater than about −110 kJ/mol), inclusive of all values and ranges therebetween. In some embodiments, the solvation energy between the Li⁺ ions and at least one of the first electrolyte solvent 112a, the second electrolyte solvent 112b, the third electrolyte solvent 112c, the fourth electrolyte solvent 112d, or the fifth electrolyte solvent 112e can be about −40 k/mol, about −50 kJ/mol, about −60 kJ/mol, about −70 kJ/mol, about −80 kJ/mol, about −90 kJ/mol, about −100 kJ/mol, about −110 kJ/mol, about −120 kJ/mol, about −130 kJ/mol, about −140 kJ/mol, about −150 kJ/mol, or about −160 kJ/mol.

In some embodiments, the de-solvation energy of the electrolyte 110 can be less than about −40 kJ/mol, less than about −50 kJ/mol, less than about −60 kJ/mol, less than about −70 kJ/mol, less than about −80 kJ/mol, less than about −90 kJ/mol, less than about −100 kJ/mol, less than about −110 k/mol, less than about −120 kJ/mol, less than about −130 kJ/mol, less than about −140 kJ/mol, or less than about −150 kJ/mol. In some embodiments, the de-solvation energy of the electrolyte 110 can be greater than about −160 kJ/mol, greater than about −150 kJ/mol, greater than about −140 kJ/mol, greater than about −130 kJ/mol, greater than about −120 kJ/mol, greater than about −110 kJ/mol, greater than about −100 kJ/mol, greater than about −90 kJ/mol, greater than about −80 kJ/mol, greater than about −70 kJ/mol, greater than about −60 kJ/mol, or greater than about −50 kJ/mol. Combinations of the above-referenced de-solvation energies are also possible (e.g., less than about −40 kJ/mol and greater than about −160 kJ/mol or less than about −60 kJ/mol and greater than about −110 kJ/mol), inclusive of all values and ranges therebetween. In some embodiments, the de-solvation energy of the electrolyte 110 can be about −40 kJ/mol, about −50 kJ/mol, about −60 kJ/mol, about −70 kJ/mol, about −80 kJ/mol, about −90 kJ/mol, about −100 kJ/mol, about −110 kJ/mol, about −120 kJ/mol, about −130 kJ/mol, about −140 kJ/mol, about −150 kJ/mol, or about −160 kJ/mol.

In some embodiments, the first salt 114a can function as an ion carrier. In some embodiments, the first salt 114a can include bis(fluorosulfonyl)imide ions, hexafluorophosphate ions, lithium bis(fluorosulfonyl)imide (F₂LiNO₄S₂), lithium bis(trifluoromethylsulfonyl)imide (LiC₂F₅NO₄S₂), lithium bis(oxalato)borate, lithium hexafluorophosphate (LiPF₆), lithium hexafluoroarsenate (LiAsF₆), lithium bis(trifluoromethane) sulfonimide (LiN(SO₂CF₃)₂), lithium trifluoromethanesulfonate (LiCF₃SO₃), lithium perchlorate (LiClO₄), lithium difluoro oxalato borate anion (LiBF₂(C₂O₄)), lithium iodide (LiI), lithium bromide (LiBr), lithium chloride (LiCl), lithium hydroxide (LiOH), lithium nitrate (LiNO₃), lithium 2-trifluoromethyl-4,5-dicyanoimidazole (LiTDI), lithium sulfate (Li₂SO₄), lithium tetrafluoroborate (LiBF₄), lithium difluorophosphate (LiPO₂F₂), sodium bis(fluorosulfonyl)imide, sodium bis(trifluoromethylsulfonyl)imide, sodium bis(oxalato)borate, sodium hexafluorophosphate, sodium hexafluoroarsenate, sodium bis(trifluoromethane) sulfonimide, sodium trifluoromethanesulfonate, sodium perchlorate, sodium difluoro oxalato borate anion, sodium iodide, sodium bromide, sodium chloride, sodium hydroxide, sodium nitrate, sodium 2-trifluoromethyl-4,5-dicyanoimidazole, sodium sulfate, sodium tetrafluoroborate, sodium difluorophosphate, potassium bis(fluorosulfonyl)imide, potassium bis(trifluoromethylsulfonyl)imide, potassium bis(oxalato)borate, potassium hexafluorophosphate, potassium hexafluoroarsenate, potassium bis(trifluoromethane) sulfonimide, potassium trifluoromethanesulfonate, potassium perchlorate, potassium difluoro oxalato borate anion, potassium iodide, potassium bromide, potassium chloride, potassium hydroxide, potassium nitrate, potassium 2-trifluoromethyl-4,5-dicyanoimidazole, potassium sulfate, potassium tetrafluoroborate, potassium difluorophosphate, magnesium bis(fluorosulfonyl)imide, magnesium bis(trifluoromethylsulfonyl)imide, magnesium bis(oxalato)borate, magnesium hexafluorophosphate, magnesium hexafluoroarsenate, magnesium bis(trifluoromethane) sulfonimide, magnesium trifluoromethanesulfonate, magnesium perchlorate, magnesium difluoro oxalato borate anion, magnesium iodide, magnesium bromide, magnesium chloride, magnesium hydroxide, magnesium nitrate, magnesium 2-trifluoromethyl-4,5-dicyanoimidazole, magnesium sulfate, magnesium tetrafluoroborate, magnesium difluorophosphate, zinc bis(fluorosulfonyl)imide, zinc bis(trifluoromethylsulfonyl)imide, zinc bis(oxalato)borate, zinc hexafluorophosphate, zinc hexafluoroarsenate, zinc bis(trifluoromethane) sulfonimide, zinc trifluoromethanesulfonate, zinc perchlorate, zinc difluoro oxalato borate anion, zinc iodide, zinc bromide, zinc chloride, zinc hydroxide, zinc nitrate, zinc 2-trifluoromethyl-4,5-dicyanoimidazole, zinc sulfate, zinc tetrafluoroborate, zinc difluorophosphate, cesium bis(fluorosulfonyl)imide, cesium bis(trifluoromethylsulfonyl)imide, cesium bis(oxalato)borate, cesium hexafluorophosphate, cesium hexafluoroarsenate, cesium bis(trifluoromethane) sulfonimide, cesium trifluoromethanesulfonate, cesium perchlorate, cesium difluoro oxalato borate anion, cesium iodide, cesium bromide, cesium chloride, cesium hydroxide, cesium nitrate, cesium 2-trifluoromethyl-4,5-dicyanoimidazole, cesium sulfate, cesium tetrafluoroborate, cesium difluorophosphate, indium bis(fluorosulfonyl)imide, indium bis(trifluoromethylsulfonyl)imide, indium bis(oxalato)borate, indium hexafluorophosphate, indium hexafluoroarsenate, indium bis(trifluoromethane) sulfonimide, indium trifluoromethanesulfonate, indium perchlorate, indium difluoro oxalato borate anion, indium iodide, indium bromide, indium chloride, indium hydroxide, indium nitrate, indium 2-trifluoromethyl-4,5-dicyanoimidazole, indium sulfate, indium tetrafluoroborate, indium difluorophosphate, tin bis(fluorosulfonyl)imide, tin bis(trifluoromethylsulfonyl)imide, tin bis(oxalato)borate, tin hexafluorophosphate, tin hexafluoroarsenate, tin bis(trifluoromethane) sulfonimide, tin trifluoromethanesulfonate, tin perchlorate, tin difluoro oxalato borate anion, tin iodide, tin bromide, tin chloride, tin hydroxide, tin nitrate, tin 2-trifluoromethyl-4,5-dicyanoimidazole, tin sulfate, tin tetrafluoroborate, tin difluorophosphate, antimony bis(fluorosulfonyl)imide, antimony bis(trifluoromethylsulfonyl)imide, antimony bis(oxalato)borate, antimony hexafluorophosphate, antimony hexafluoroarsenate, antimony bis(trifluoromethane) sulfonimide, antimony trifluoromethanesulfonate, antimony perchlorate, antimony difluoro oxalato borate anion, antimony iodide, antimony bromide, antimony chloride, antimony hydroxide, antimony nitrate, antimony 2-trifluoromethyl-4,5-dicyanoimidazole, antimony sulfate, antimony tetrafluoroborate, antimony difluorophosphate, silicon bis(fluorosulfonyl)imide, silicon bis(trifluoromethylsulfonyl)imide, silicon bis(oxalato)borate, silicon hexafluorophosphate, silicon hexafluoroarsenate, silicon bis(trifluoromethane) sulfonimide, silicon trifluoromethanesulfonate, silicon perchlorate, silicon difluoro oxalato borate anion, silicon iodide, silicon bromide, silicon chloride, silicon hydroxide, silicon nitrate, silicon 2-trifluoromethyl-4,5-dicyanoimidazole, silicon sulfate, silicon tetrafluoroborate, silicon difluorophosphate, nickel bis(fluorosulfonyl)imide, nickel bis(trifluoromethylsulfonyl)imide, nickel bis(oxalato)borate, nickel hexafluorophosphate, nickel hexafluoroarsenate, nickel bis(trifluoromethane) sulfonimide, nickel trifluoromethanesulfonate, nickel perchlorate, nickel difluoro oxalato borate anion, nickel iodide, nickel bromide, nickel chloride, nickel hydroxide, nickel nitrate, nickel 2-trifluoromethyl-4,5-dicyanoimidazole, nickel sulfate, nickel tetrafluoroborate, nickel difluorophosphate, cobalt bis(fluorosulfonyl)imide, cobalt bis(trifluoromethylsulfonyl)imide, cobalt bis(oxalato)borate, cobalt hexafluorophosphate, cobalt hexafluoroarsenate, cobalt bis(trifluoromethane) sulfonimide, cobalt trifluoromethanesulfonate, cobalt perchlorate, cobalt difluoro oxalato borate anion, cobalt iodide, cobalt bromide, cobalt chloride, cobalt hydroxide, cobalt nitrate, cobalt 2-trifluoromethyl-4,5-dicyanoimidazole, cobalt sulfate, cobalt tetrafluoroborate, cobalt difluorophosphate, or any combination thereof.

In some embodiments, the first salt 114a can make up at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt % of the electrolyte 110. In some embodiments, the first salt 114a can make up no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, or no more than about 6 wt % of the electrolyte 110. Combinations of the above-referenced percentages are also possible (e.g., at least about 5 wt % and no more than about 30 wt % or at least about 10 wt % and no more than about 20 wt %), inclusive of all values and ranges therebetween. In some embodiments, the first salt 114a can make up about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the electrolyte 110.

In some embodiments, the second salt 114b can be different from the first salt 114a. In some embodiments, the second salt 114b can include bis(fluorosulfonyl)imide ions, hexafluorophosphate ions, lithium bis(fluorosulfonyl)imide (F₂LiNO₄S₂), lithium bis(trifluoromethylsulfonyl)imide (LiC₂F₆NO₄S₂), lithium bis(oxalato)borate, lithium hexafluorophosphate (LiPF₆), lithium hexafluoroarsenate (LiAsF₆), lithium bis(trifluoromethane) sulfonimide (LiN(SO₂CF₃)₂), lithium trifluoromethanesulfonate (LiCF₃SO₃), lithium perchlorate (LiClO₄), lithium difluoro oxalato borate anion (LiBF₂(C₂O₄)), lithium iodide (LiI), lithium bromide (LiBr), lithium chloride (LiCl), lithium hydroxide (LiOH), lithium nitrate (LiNO₃), lithium 2-trifluoromethyl-4,5-dicyanoimidazole (LiTDI), lithium sulfate (Li₂SO₄), lithium tetrafluoroborate (LiBF₄), lithium difluorophosphate (LiPO₂F₂), sodium bis(fluorosulfonyl)imide, sodium bis(trifluoromethylsulfonyl)imide, sodium bis(oxalato)borate, sodium hexafluorophosphate, sodium hexafluoroarsenate, sodium bis(trifluoromethane) sulfonimide, sodium trifluoromethanesulfonate, sodium perchlorate, sodium difluoro oxalato borate anion, sodium iodide, sodium bromide, sodium chloride, sodium hydroxide, sodium nitrate, sodium 2-trifluoromethyl-4,5-dicyanoimidazole, sodium sulfate, sodium tetrafluoroborate, sodium difluorophosphate, potassium bis(fluorosulfonyl)imide, potassium bis(trifluoromethylsulfonyl)imide, potassium bis(oxalato)borate, potassium hexafluorophosphate, potassium hexafluoroarsenate, potassium bis(trifluoromethane) sulfonimide, potassium trifluoromethanesulfonate, potassium perchlorate, potassium difluoro oxalato borate anion, potassium iodide, potassium bromide, potassium chloride, potassium hydroxide, potassium nitrate, potassium 2-trifluoromethyl-4,5-dicyanoimidazole, potassium sulfate, potassium tetrafluoroborate, potassium difluorophosphate, magnesium bis(fluorosulfonyl)imide, magnesium bis(trifluoromethylsulfonyl)imide, magnesium bis(oxalato)borate, magnesium hexafluorophosphate, magnesium hexafluoroarsenate, magnesium bis(trifluoromethane) sulfonimide, magnesium trifluoromethanesulfonate, magnesium perchlorate, magnesium difluoro oxalato borate anion, magnesium iodide, magnesium bromide, magnesium chloride, magnesium hydroxide, magnesium nitrate, magnesium 2-trifluoromethyl-4,5-dicyanoimidazole, magnesium sulfate, magnesium tetrafluoroborate, magnesium difluorophosphate, zinc bis(fluorosulfonyl)imide, zinc bis(trifluoromethylsulfonyl)imide, zinc bis(oxalato)borate, zinc hexafluorophosphate, zinc hexafluoroarsenate, zinc bis(trifluoromethane) sulfonimide, zinc trifluoromethanesulfonate, zinc perchlorate, zinc difluoro oxalato borate anion, zinc iodide, zinc bromide, zinc chloride, zinc hydroxide, zinc nitrate, zinc 2-trifluoromethyl-4,5-dicyanoimidazole, zinc sulfate, zinc tetrafluoroborate, zinc difluorophosphate, cesium bis(fluorosulfonyl)imide, cesium bis(trifluoromethylsulfonyl)imide, cesium bis(oxalato)borate, cesium hexafluorophosphate, cesium hexafluoroarsenate, cesium bis(trifluoromethane) sulfonimide, cesium trifluoromethanesulfonate, cesium perchlorate, cesium difluoro oxalato borate anion, cesium iodide, cesium bromide, cesium chloride, cesium hydroxide, cesium nitrate, cesium 2-trifluoromethyl-4,5-dicyanoimidazole, cesium sulfate, cesium tetrafluoroborate, cesium difluorophosphate, indium bis(fluorosulfonyl)imide, indium bis(trifluoromethylsulfonyl)imide, indium bis(oxalato)borate, indium hexafluorophosphate, indium hexafluoroarsenate, indium bis(trifluoromethane) sulfonimide, indium trifluoromethanesulfonate, indium perchlorate, indium difluoro oxalato borate anion, indium iodide, indium bromide, indium chloride, indium hydroxide, indium nitrate, indium 2-trifluoromethyl-4,5-dicyanoimidazole, indium sulfate, indium tetrafluoroborate, indium difluorophosphate, tin bis(fluorosulfonyl)imide, tin bis(trifluoromethylsulfonyl)imide, tin bis(oxalato)borate, tin hexafluorophosphate, tin hexafluoroarsenate, tin bis(trifluoromethane) sulfonimide, tin trifluoromethanesulfonate, tin perchlorate, tin difluoro oxalato borate anion, tin iodide, tin bromide, tin chloride, tin hydroxide, tin nitrate, tin 2-trifluoromethyl-4,5-dicyanoimidazole, tin sulfate, tin tetrafluoroborate, tin difluorophosphate, antimony bis(fluorosulfonyl)imide, antimony bis(trifluoromethylsulfonyl)imide, antimony bis(oxalato)borate, antimony hexafluorophosphate, antimony hexafluoroarsenate, antimony bis(trifluoromethane) sulfonimide, antimony trifluoromethanesulfonate, antimony perchlorate, antimony difluoro oxalato borate anion, antimony iodide, antimony bromide, antimony chloride, antimony hydroxide, antimony nitrate, antimony 2-trifluoromethyl-4,5-dicyanoimidazole, antimony sulfate, antimony tetrafluoroborate, antimony difluorophosphate, silicon bis(fluorosulfonyl)imide, silicon bis(trifluoromethylsulfonyl)imide, silicon bis(oxalato)borate, silicon hexafluorophosphate, silicon hexafluoroarsenate, silicon bis(trifluoromethane) sulfonimide, silicon trifluoromethanesulfonate, silicon perchlorate, silicon difluoro oxalato borate anion, silicon iodide, silicon bromide, silicon chloride, silicon hydroxide, silicon nitrate, silicon 2-trifluoromethyl-4,5-dicyanoimidazole, silicon sulfate, silicon tetrafluoroborate, silicon difluorophosphate, nickel bis(fluorosulfonyl)imide, nickel bis(trifluoromethylsulfonyl)imide, nickel bis(oxalato)borate, nickel hexafluorophosphate, nickel hexafluoroarsenate, nickel bis(trifluoromethane) sulfonimide, nickel trifluoromethanesulfonate, nickel perchlorate, nickel difluoro oxalato borate anion, nickel iodide, nickel bromide, nickel chloride, nickel hydroxide, nickel nitrate, nickel 2-trifluoromethyl-4,5-dicyanoimidazole, nickel sulfate, nickel tetrafluoroborate, nickel difluorophosphate, cobalt bis(fluorosulfonyl)imide, cobalt bis(trifluoromethylsulfonyl)imide, cobalt bis(oxalato)borate, cobalt hexafluorophosphate, cobalt hexafluoroarsenate, cobalt bis(trifluoromethane) sulfonimide, cobalt trifluoromethanesulfonate, cobalt perchlorate, cobalt difluoro oxalato borate anion, cobalt iodide, cobalt bromide, cobalt chloride, cobalt hydroxide, cobalt nitrate, cobalt 2-trifluoromethyl-4,5-dicyanoimidazole, cobalt sulfate, cobalt tetrafluoroborate, cobalt difluorophosphate, or any combination thereof.

In some embodiments, the second salt 114b can make up at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, or at least about 9 wt % of the electrolyte 110. In some embodiments, the second salt 114b can make up no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the electrolyte 110. Combinations of the above-referenced percentages are also possible (e.g., at least about 0.1 wt % and no more than about 10 wt % or at least about 1 wt % and no more than about 5 wt %), inclusive of all values and ranges therebetween. In some embodiments, the second salt 114b can make up about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, or about 10 wt % of the electrolyte 110.

In some embodiments, the first salt 114a and the second salt 114b can collectively make up at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt % of the electrolyte 110. In some embodiments, the first salt 114a and the second salt 114b can collectively make up no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, or no more than about 6 wt % of the electrolyte 110. Combinations of the above-referenced percentages are also possible (e.g., at least about 5 wt % and no more than about 25 wt % or at least about 10 wt % and no more than about 20 wt %), inclusive of all values and ranges therebetween. In some embodiments, the first salt 114a and the second salt 114b can make up about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the electrolyte 110.

In some embodiments, the third salt 114c can be different from the first salt 114a and the second salt 114b. In some embodiments, the third salt 114c can include bis(fluorosulfonyl)imide ions, hexafluorophosphate ions, lithium bis(fluorosulfonyl)imide (F₂LiNO₄S₂), lithium bis(trifluoromethylsulfonyl)imide (LiC₂F₆NO₄S₂), lithium bis(oxalato)borate, lithium hexafluorophosphate (LiPF₆), lithium hexafluoroarsenate (LiAsF₆), lithium bis(trifluoromethane) sulfonimide (LiN(SO₂CF₃)₂), lithium trifluoromethanesulfonate (LiCF₃SO₃), lithium perchlorate (LiClO₄), lithium difluoro oxalato borate anion (LiBF₂(C₂O₄)), lithium iodide (LiI), lithium bromide (LiBr), lithium chloride (LiCl), lithium hydroxide (LiOH), lithium nitrate (LiNO₃), lithium 2-trifluoromethyl-4,5-dicyanoimidazole (LiTDI), lithium sulfate (Li₂SO₄), lithium tetrafluoroborate (LiBF₄), lithium difluorophosphate (LiPO₂F₂), sodium bis(fluorosulfonyl)imide, sodium bis(trifluoromethylsulfonyl)imide, sodium bis(oxalato)borate, sodium hexafluorophosphate, sodium hexafluoroarsenate, sodium bis(trifluoromethane) sulfonimide, sodium trifluoromethanesulfonate, sodium perchlorate, sodium difluoro oxalato borate anion, sodium iodide, sodium bromide, sodium chloride, sodium hydroxide, sodium nitrate, sodium 2-trifluoromethyl-4,5-dicyanoimidazole, sodium sulfate, sodium tetrafluoroborate, sodium difluorophosphate, potassium bis(fluorosulfonyl)imide, potassium bis(trifluoromethylsulfonyl)imide, potassium bis(oxalato)borate, potassium hexafluorophosphate, potassium hexafluoroarsenate, potassium bis(trifluoromethane) sulfonimide, potassium trifluoromethanesulfonate, potassium perchlorate, potassium difluoro oxalato borate anion, potassium iodide, potassium bromide, potassium chloride, potassium hydroxide, potassium nitrate, potassium 2-trifluoromethyl-4,5-dicyanoimidazole, potassium sulfate, potassium tetrafluoroborate, potassium difluorophosphate, magnesium bis(fluorosulfonyl)imide, magnesium bis(trifluoromethylsulfonyl)imide, magnesium bis(oxalato)borate, magnesium hexafluorophosphate, magnesium hexafluoroarsenate, magnesium bis(trifluoromethane) sulfonimide, magnesium trifluoromethanesulfonate, magnesium perchlorate, magnesium difluoro oxalato borate anion, magnesium iodide, magnesium bromide, magnesium chloride, magnesium hydroxide, magnesium nitrate, magnesium 2-trifluoromethyl-4,5-dicyanoimidazole, magnesium sulfate, magnesium tetrafluoroborate, magnesium difluorophosphate, zinc bis(fluorosulfonyl)imide, zinc bis(trifluoromethylsulfonyl)imide, zinc bis(oxalato)borate, zinc hexafluorophosphate, zinc hexafluoroarsenate, zinc bis(trifluoromethane) sulfonimide, zinc trifluoromethanesulfonate, zinc perchlorate, zinc difluoro oxalato borate anion, zinc iodide, zinc bromide, zinc chloride, zinc hydroxide, zinc nitrate, zinc 2-trifluoromethyl-4,5-dicyanoimidazole, zinc sulfate, zinc tetrafluoroborate, zinc difluorophosphate, cesium bis(fluorosulfonyl)imide, cesium bis(trifluoromethylsulfonyl)imide, cesium bis(oxalato)borate, cesium hexafluorophosphate, cesium hexafluoroarsenate, cesium bis(trifluoromethane) sulfonimide, cesium trifluoromethanesulfonate, cesium perchlorate, cesium difluoro oxalato borate anion, cesium iodide, cesium bromide, cesium chloride, cesium hydroxide, cesium nitrate, cesium 2-trifluoromethyl-4,5-dicyanoimidazole, cesium sulfate, cesium tetrafluoroborate, cesium difluorophosphate, indium bis(fluorosulfonyl)imide, indium bis(trifluoromethylsulfonyl)imide, indium bis(oxalato)borate, indium hexafluorophosphate, indium hexafluoroarsenate, indium bis(trifluoromethane) sulfonimide, indium trifluoromethanesulfonate, indium perchlorate, indium difluoro oxalato borate anion, indium iodide, indium bromide, indium chloride, indium hydroxide, indium nitrate, indium 2-trifluoromethyl-4,5-dicyanoimidazole, indium sulfate, indium tetrafluoroborate, indium difluorophosphate, tin bis(fluorosulfonyl)imide, tin bis(trifluoromethylsulfonyl)imide, tin bis(oxalato)borate, tin hexafluorophosphate, tin hexafluoroarsenate, tin bis(trifluoromethane) sulfonimide, tin trifluoromethanesulfonate, tin perchlorate, tin difluoro oxalato borate anion, tin iodide, tin bromide, tin chloride, tin hydroxide, tin nitrate, tin 2-trifluoromethyl-4,5-dicyanoimidazole, tin sulfate, tin tetrafluoroborate, tin difluorophosphate, antimony bis(fluorosulfonyl)imide, antimony bis(trifluoromethylsulfonyl)imide, antimony bis(oxalato)borate, antimony hexafluorophosphate, antimony hexafluoroarsenate, antimony bis(trifluoromethane) sulfonimide, antimony trifluoromethanesulfonate, antimony perchlorate, antimony difluoro oxalato borate anion, antimony iodide, antimony bromide, antimony chloride, antimony hydroxide, antimony nitrate, antimony 2-trifluoromethyl-4,5-dicyanoimidazole, antimony sulfate, antimony tetrafluoroborate, antimony difluorophosphate, silicon bis(fluorosulfonyl)imide, silicon bis(trifluoromethylsulfonyl)imide, silicon bis(oxalato)borate, silicon hexafluorophosphate, silicon hexafluoroarsenate, silicon bis(trifluoromethane) sulfonimide, silicon trifluoromethanesulfonate, silicon perchlorate, silicon difluoro oxalato borate anion, silicon iodide, silicon bromide, silicon chloride, silicon hydroxide, silicon nitrate, silicon 2-trifluoromethyl-4,5-dicyanoimidazole, silicon sulfate, silicon tetrafluoroborate, silicon difluorophosphate, nickel bis(fluorosulfonyl)imide, nickel bis(trifluoromethylsulfonyl)imide, nickel bis(oxalato)borate, nickel hexafluorophosphate, nickel hexafluoroarsenate, nickel bis(trifluoromethane) sulfonimide, nickel trifluoromethanesulfonate, nickel perchlorate, nickel difluoro oxalato borate anion, nickel iodide, nickel bromide, nickel chloride, nickel hydroxide, nickel nitrate, nickel 2-trifluoromethyl-4,5-dicyanoimidazole, nickel sulfate, nickel tetrafluoroborate, nickel difluorophosphate, cobalt bis(fluorosulfonyl)imide, cobalt bis(trifluoromethylsulfonyl)imide, cobalt bis(oxalato)borate, cobalt hexafluorophosphate, cobalt hexafluoroarsenate, cobalt bis(trifluoromethane) sulfonimide, cobalt trifluoromethanesulfonate, cobalt perchlorate, cobalt difluoro oxalato borate anion, cobalt iodide, cobalt bromide, cobalt chloride, cobalt hydroxide, cobalt nitrate, cobalt 2-trifluoromethyl-4,5-dicyanoimidazole, cobalt sulfate, cobalt tetrafluoroborate, cobalt difluorophosphate, or any combination thereof.

In some embodiments, the third salt 114c can make up at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, or at least about 9 wt % of the electrolyte 110. In some embodiments, the third salt 114c can make up no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the electrolyte 110. Combinations of the above-referenced percentages are also possible (e.g., at least about 0.1 wt % and no more than about 10 wt % or at least about 1 wt % and no more than about 5 wt %), inclusive of all values and ranges therebetween. In some embodiments, the third salt 114c can make up about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, or about 10 wt % of the electrolyte 110.

In some embodiments, the first salt 114a, the second salt 114b, or the third salt 114c can have a concentration in the electrolyte 110 of at least about 1 M, at least about 1.1 M, at least about 1.2 M, at least about 1.3 M, at least about 1.4 M, at least about 1.5 M, at least about 1.6 M, at least about 1.7 M, at least about 1.8 M, at least about 1.9 M, at least about 2 M, at least about 2.1 M, at least about 2.2 M, at least about 2.3 M, at least about 2.4 M, at least about 2.5 M, at least about 2.6 M, at least about 2.7 M, at least about 2.8 M, or at least about 2.9 M. In some embodiments, the first salt 114a, the second salt 114b, and/or the third salt 114 can have a concentration in the electrolyte 110 of no more than about 3 M, no more than about 2.9 M, no more than about 2.8 M, no more than about 2.7 M, no more than about 2.6 M, no more than about 2.5 M, no more than about 2.4 M, no more than about 2.3 M, no more than about 2.2 M, no more than about 2.1 M, no more than about 2 M, no more than about 1.9 M, no more than about 1.8 M, no more than about 1.7 M, no more than about 1.6 M, no more than about 1.5 M, no more than about 1.4 M, no more than about 1.3 M, no more than about 1.2 M, no more than about 1.1 M. Combinations of the above-referenced concentrations are also possible (e.g., at least about 1 M and no more than about 3 M or at least about 2.2 M and no more than about 2.8 M), inclusive of all values and ranges therebetween. In some embodiments, the first salt 114a, the second salt 114b, and/or the third salt 114c can have a concentration in the electrolyte 110 of about 1 M, about 1.1 M, about 1.2 M, about 1.3 M, about 1.4 M, about 1.5 M, about 1.6 M, about 1.7 M, about 1.8 M, about 1.9 M, about 2 M, about 2.1 M, about 2.2 M, about 2.3 M, about 2.4 M, about 2.5 M, about 2.6 M, about 2.7 M, about 2.8 M, about 2.9 M, or about 3 M.

In some embodiments, the first salt 114a, the second salt 114b, and/or the third salt 114c can have a miscibility limit (i.e., a maximum amount of salt soluble in solution(s)) in the first electrolyte solvent 112a, the second electrolyte solvent 112b, the third electrolyte solvent 112c, the fourth electrolyte solvent 112d, and/or the fifth electrolyte solvent 112e of at least about 20 g/L, at least about 30 g/L, at least about 40 g/L, at least about 50 g/L, at least about 60 g/L, at least about 70 g/L, at least about 80 g/L, at least about 90 g/L, at least about 100 g/L, at least about 150 g/L, at least about 200 g/L, at least about 250 g/L, at least about 300 g/L, at least about 350 g/L, at least about 400 g/L, at least about 450 g/L, or at least about 500 g/L, inclusive of all values and ranges therebetween.

In some embodiments, the first additive 115a can include a fire retardant. In some embodiments, the first additive 115a can include lithium difluorophosphate (LiPO₂F₂), vinylene carbonate, fluoroethylene carbonate, difluoroethylene carbonate, bis(2,2,2-trifluoroethyl) carbonate, 1,3,2-dioxathiolan-2,2-dioxide, propene sultone, 1,2,6-oxadithiane 2,2,6,6-tetraoxide, lithium tetrafluoro(oxalato)phosphate, lithium difluoro(dioxalato)phosphate, phenylpropenenitrile, 3-cyanothiophene, trimethylsilylcarbonitrile, butanedinitrile, hexanetricarbonitrile, bis(trimethylsilyl) malonate, 1,2,3,4-tetrakis(trimethylsilyl) 1,2,3,4-butanetetracarboxylate, 1,3-bis(trimethylsilyl) 2,2-dimethylpropanedioate, trimethylsilyl 2-methyl-2-[(trimethylsilyl)oxy]propanoate, 1,4-bis(trimethylsilyl) 2-butenedioate, tris(trimethylsilyl)amine, 1,2,3-tris(trimethylsilyl) 2-[(trimethylsilyl)oxy]-1,2,3-propanetricarboxylate, 1,2,3-tris(trimethylsilyl) I-propene-1,2,3-tricarboxylate, trimethylsiloxyacetate, trially phosphate tris- (trimethylsilyl) phosphate (TMSP), tris(trimethylsilyl) phosphite (TMSPi), trioctyl phosphate (TOP), trimethoxy(3,3,3-trifluoropropyl)silane (TTS), pentafluorophenyltriethoxysilane (TPS), boric acid tris(trimethylsilyl) ester (TMSB), tris- (pentafluorophenyl)silane (TPFPS), 1,10-sulfonyldiimidazole (SDM), trioxane, lithium difluorophosphate, lithium difluoro oxalato borate, lithium nitrate, (pentafluorophenyl)diphenylphosphine (PFPDPP), cetyltrimethylammonium bromide (CTAB), sodium dodecyl sulfate (SDS), polyethylene-glycol (PEG-8000), and thiourea (TU), benzotriazole (BTA), thiourea (CH4N2S), sodium dodecyl benzene sulfonate (SDBS), LiTFSI, poly(vinyl alcohol) (PVA), polyethylene glycol (PEG), carboxymethyl cellulose (CMC), an organic phosphate, a phosphite, a phosphoramide, a substituted aliphatic phosphate, a substituted aryl phosphate, an unsubstituted aliphatic phosphate, an unsubstituted aryl phosphate, a phosphonate, a phosphoramide, a phosphazene, an inorganic phosphazene, an inorganic phosphazene, or any combination thereof. In some embodiments, the first additive 115a can include a polymer. In some embodiments, the first additive 115a can include polyvinylidene fluoride (PVDF), poly(vinylidene fluoride-hexafluoropropylene) (PVDF-HFP), polyimide (PI), CMC, poly(acrylic acid) (PAA), PEG, polyaniline (PANI) polyacrylonitrile (PAN), poly(methyl methacrylate) (PMMA), polypropylene carbonate (PPC), polyvinylpyrrolidone (PVP), polydimethylsiloxane (PDMS), polyamide (nylon), or any combination thereof.

In some embodiments, the first additive 115a can make up at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, at least about 2 wt %, at least about 2.5 wt %, at least about 3 wt %, at least about 3.5 wt %, at least about 4 wt %, or at least about 4.5 wt % of the electrolyte 110. In some embodiments, the first additive 115a can make up no more than about 5 wt %, no more than about 4.5 wt %, no more than about 4 wt %, no more than about 3.5 wt %, no more than about 4 wt %, no more than about 2.5 wt %, no more than about 2 wt %, no more than about 1.9 wt %, no more than about 1.8 wt %, no more than about 1.7 wt %, no more than about 1.6 wt %, no more than about 1.5 wt %, no more than about 1.4 wt %, no more than about 1.3 wt %, no more than about 1.2 wt %, no more than about 1.1 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the electrolyte 110. Combinations of the above-referenced percentages are also possible (e.g., at least about 0.1 wt % and no more than about 5 wt % or at least about 1 wt % and no more than about 2 wt %), inclusive of all values and ranges therebetween. In some embodiments, the first additive 115a can make up about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.5 wt %, about 3 wt %, about 3.5 wt %, about 4 wt %, about 4.5 wt %, or about 5 wt % of the electrolyte 110.

In some embodiments, the second additive 115b can be different from the first additive 115a. In some embodiments, the second additive 115b can include a fire retardant. In some embodiments, the second additive 115b can include lithium difluorophosphate (LiPO₂F₂), vinylene carbonate, fluoroethylene carbonate, difluoroethylene carbonate, bis(2,2,2-trifluoroethyl) carbonate, 1,3,2-dioxathiolan-2,2-dioxide, propene sultone, 1,2,6-oxadithiane 2,2,6,6-tetraoxide, lithium tetrafluoro(oxalato)phosphate, lithium difluoro(dioxalato)phosphate, phenylpropenenitrile, 3-cyanothiophene, trimethylsilylcarbonitrile, butanedinitrile, hexanetricarbonitrile, bis(trimethylsilyl) malonate, 1,2,3,4-tetrakis(trimethylsilyl) 1,2,3,4-butanetetracarboxylate, 1,3-bis(trimethylsilyl) 2,2-dimethylpropanedioate, trimethylsilyl 2-methyl-2-[(trimethylsilyl)oxy]propanoate, 1,4-bis(trimethylsilyl) 2-butenedioate, tris(trimethylsilyl)amine, 1,2,3-tris(trimethylsilyl) 2-[(trimethylsilyl)oxy]-1,2,3-propanetricarboxylate, 1,2,3-tris(trimethylsilyl) 1-propene-1,2,3-tricarboxylate, trimethylsiloxyacetate, trially phosphate tris- (trimethylsilyl) phosphate (TMSP), tris(trimethylsilyl) phosphite (TMSPi), trioctyl phosphate (TOP), trimethoxy(3,3,3-trifluoropropyl)silane (TTS), pentafluorophenyltriethoxysilane (TPS), boric acid tris(trimethylsilyl) ester (TMSB), tris- (pentafluorophenyl)silane (TPFPS), 1,10-sulfonyldiimidazole (SDM), trioxane, lithium difluorophosphate, lithium difluoro oxalato borate, lithium nitrate, (pentafluorophenyl)diphenylphosphine (PFPDPP), cetyltrimethylammonium bromide (CTAB), sodium dodecyl sulfate (SDS), polyethylene-glycol (PEG-8000), and thiourea (TU), benzotriazole (BTA), thiourea (CH4N2S), sodium dodecyl benzene sulfonate (SDBS), LiTFSI, poly(vinyl alcohol) (PVA), polyethylene glycol (PEG), carboxymethyl cellulose (CMC), an organic phosphate, a phosphite, a phosphoramide, a substituted aliphatic phosphate, a substituted aryl phosphate, an unsubstituted aliphatic phosphate, an unsubstituted aryl phosphate, a phosphonate, a phosphoramide, a phosphazene, an inorganic phosphazene, an inorganic phosphazene, or any combination thereof. In some embodiments, the second additive 115b can include a polymer. In some embodiments, the second additive 115b can include polyvinylidene fluoride (PVDF), poly(vinylidene fluoride-hexafluoropropylene) (PVDF-HFP), polyimide (PI), CMC, poly(acrylic acid) (PAA), PEG, polyaniline (PANI) polyacrylonitrile (PAN), poly(methyl methacrylate) (PMMA), polypropylene carbonate (PPC), polyvinylpyrrolidone (PVP), polydimethylsiloxane (PDMS), or any combination thereof.

In some embodiments, the second additive 115b can make up at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.1 wt %, at least about 1.2 wt %, at least about 1.3 wt %%, at least about 1.4 wt %, at least about 1.5 wt %, at least about 1.6 wt %, at least about 1.7 wt %, at least about 1.8 wt %, at least about 1.9 wt %, at least about 2 wt %, at least about 2.5 wt %, at least about 3 wt %, at least about 3.5 wt %, at least about 4 wt %, or at least about 4.5 wt % of the electrolyte 110. In some embodiments, the second additive 115b can make up no more than about 5 wt %, no more than about 4.5 wt %, no more than about 4 wt %, no more than about 3.5 wt %, no more than about 4 wt %, no more than about 2.5 wt %, no more than about 2 wt %, no more than about 1.9 wt %, no more than about 1.8 wt %, no more than about 1.7 wt %, no more than about 1.6 wt %, no more than about 1.5 wt %, no more than about 1.4 wt %, no more than about 1.3 wt %, no more than about 1.2 wt %, no more than about 1.1 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the electrolyte 110. Combinations of the above-referenced percentages are also possible (e.g., at least about 0.1 wt % and no more than about 5 wt % or at least about 1 wt % and no more than about 2 wt %), inclusive of all values and ranges therebetween. In some embodiments, the second additive 115b can make up about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.5 wt %, about 3 wt %, about 3.5 wt %, about 4 wt %, about 4.5 wt %, or about 5 wt % of the electrolyte 110.

In some embodiments, the third additive 115c can be different from the second additive 115b and the first additive 115a. In some embodiments, the third additive 115c can include a fire retardant. In some embodiments, the third additive 115c can include lithium difluorophosphate (LiPO₂F₂), vinylene carbonate, fluoroethylene carbonate, difluoroethylene carbonate, bis(2,2,2-trifluoroethyl) carbonate, 1,3,2-dioxathiolan-2,2-dioxide, propene sultone, 1,2,6-oxadithiane 2,2,6,6-tetraoxide, lithium tetrafluoro(oxalato)phosphate, lithium difluoro(dioxalato)phosphate, phenylpropenenitrile, 3-cyanothiophene, trimethylsilylcarbonitrile, butanedinitrile, hexanetricarbonitrile, bis(trimethylsilyl) malonate, 1,2,3,4-tetrakis(trimethylsilyl) 1,2,3,4-butanetetracarboxylate, 1,3-bis(trimethylsilyl) 2,2-dimethylpropanedioate, trimethylsilyl 2-methyl-2-[(trimethylsilyl)oxy]propanoate, 1,4-bis(trimethylsilyl) 2-butenedioate, tris(trimethylsilyl)amine, 1,2,3-tris(trimethylsilyl) 2-[(trimethylsilyl)oxy]-1,2,3-propanetricarboxylate, 1,2,3-tris(trimethylsilyl) 1-propene-1,2,3-tricarboxylate, trimethylsiloxyacetate, trially phosphate tris- (trimethylsilyl) phosphate (TMSP), tris(trimethylsilyl) phosphite (TMSPi), trioctyl phosphate (TOP), trimethoxy(3,3,3-trifluoropropyl)silane (TTS), pentafluorophenyltriethoxysilane (TPS), boric acid tris(trimethylsilyl) ester (TMSB), tris- (pentafluorophenyl)silane (TPFPS), 1,10-sulfonyldiimidazole (SDM), trioxane, lithium difluorophosphate, lithium difluoro oxalato borate, lithium nitrate, (pentafluorophenyl)diphenylphosphine (PFPDPP), cetyltrimethylammonium bromide (CTAB), sodium dodecyl sulfate (SDS), polyethylene-glycol (PEG-8000), and thiourea (TU), benzotriazole (BTA), thiourea (CH4N2S), sodium dodecyl benzene sulfonate (SDBS), LiTFSI, poly(vinyl alcohol) (PVA), polyethylene glycol (PEG), carboxymethyl cellulose (CMC), an organic phosphate, a phosphite, a phosphoramide, a substituted aliphatic phosphate, a substituted aryl phosphate, an unsubstituted aliphatic phosphate, an unsubstituted aryl phosphate, a phosphonate, a phosphoramide, a phosphazene, an inorganic phosphazene, an inorganic phosphazene, or any combination thereof. In some embodiments, the third additive 115c can include a polymer. In some embodiments, the third additive 115c can include polyvinylidene fluoride (PVDF), poly(vinylidene fluoride-hexafluoropropylene) (PVDF-HFP), polyimide (PI), CMC, poly(acrylic acid) (PAA), PEG, polyaniline (PANI) polyacrylonitrile (PAN), poly(methyl methacrylate) (PMMA), polypropylene carbonate (PPC), polyvinylpyrrolidone (PVP), polydimethylsiloxane (PDMS), or any combination thereof.

In some embodiments, the third additive 115c can make up at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, at least about 2 wt %, at least about 2.5 wt %, at least about 3 wt %, at least about 3.5 wt %, at least about 4 wt %, or at least about 4.5 wt % of the electrolyte 110. In some embodiments, the third additive 115c can make up no more than about 5 wt %, no more than about 4.5 wt %, no more than about 4 wt %, no more than about 3.5 wt %, no more than about 4 wt %, no more than about 2.5 wt %, no more than about 2 wt %, no more than about 1.9 wt %, no more than about 1.8 wt %, no more than about 1.7 wt %, no more than about 1.6 wt %, no more than about 1.5 wt %, no more than about 1.4 wt %, no more than about 1.3 wt %, no more than about 1.2 wt %, no more than about 1.1 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the electrolyte 110. Combinations of the above-referenced percentages are also possible (e.g., at least about 0.1 wt % and no more than about 5 wt % or at least about 1 wt % and no more than about 2 wt %), inclusive of all values and ranges therebetween. In some embodiments, the third additive 115c can make up about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.5 wt %, about 3 wt %, about 3.5 wt %, about 4 wt %, about 4.5 wt %, or about 5 wt % of the electrolyte 110.

In some embodiments, the fourth additive 115d can be different from the first additive 115a, the second additive 115b, and the third additive 115c. In some embodiments, the fourth additive 115d can include a fire retardant. In some embodiments, the fourth additive 115d can include lithium difluorophosphate (LiPO₂F₂), vinylene carbonate, fluoroethylene carbonate, difluoroethylene carbonate, bis(2,2,2-trifluoroethyl) carbonate, 1,3,2-dioxathiolan-2,2-dioxide, propene sultone, 1,2,6-oxadithiane 2,2,6,6-tetraoxide, lithium tetrafluoro(oxalato)phosphate, lithium difluoro(dioxalato)phosphate, phenylpropenenitrile, 3-cyanothiophene, trimethylsilylcarbonitrile, butanedinitrile, hexanetricarbonitrile, bis(trimethylsilyl) malonate, 1,2,3,4-tetrakis(trimethylsilyl) 1,2,3,4-butanetetracarboxylate, 1,3-bis(trimethylsilyl) 2,2-dimethylpropanedioate, trimethylsilyl 2-methyl-2-[(trimethylsilyl)oxy]propanoate, 1,4-bis(trimethylsilyl) 2-butenedioate, tris(trimethylsilyl)amine, 1,2,3-tris(trimethylsilyl) 2-[(trimethylsilyl)oxy]-1,2,3-propanetricarboxylate, 1,2,3-tris(trimethylsilyl) 1-propene-1,2,3-tricarboxylate, trimethylsiloxyacetate, trially phosphate tris- (trimethylsilyl) phosphate (TMSP), tris(trimethylsilyl) phosphite (TMSPi), trioctyl phosphate (TOP), trimethoxy(3,3,3-trifluoropropyl)silane (TTS), pentafluorophenyltriethoxysilane (TPS), boric acid tris(trimethylsilyl) ester (TMSB), tris- (pentafluorophenyl)silane (TPFPS), 1,10-sulfonyldiimidazole (SDM), trioxane, lithium difluorophosphate, lithium difluoro oxalato borate, lithium nitrate, (pentafluorophenyl)diphenylphosphine (PFPDPP), cetyltrimethylammonium bromide (CTAB), sodium dodecyl sulfate (SDS), polyethylene-glycol (PEG-8000), and thiourea (TU), benzotriazole (BTA), thiourea (CH4N2S), sodium dodecyl benzene sulfonate (SDBS), LiTFSI, poly(vinyl alcohol) (PVA), polyethylene glycol (PEG), carboxymethyl cellulose (CMC), an organic phosphate, a phosphite, a phosphoramide, a substituted aliphatic phosphate, a substituted aryl phosphate, an unsubstituted aliphatic phosphate, an unsubstituted aryl phosphate, a phosphonate, a phosphoramide, a phosphazene, an inorganic phosphazene, an inorganic phosphazene, or any combination thereof. In some embodiments, the fourth additive 115d can include a polymer. In some embodiments, the fourth additive 115d can include polyvinylidene fluoride (PVDF), poly(vinylidene fluoride-hexafluoropropylene) (PVDF-HFP), polyimide (PI), CMC, poly(acrylic acid) (PAA), PEG, polyaniline (PANI) polyacrylonitrile (PAN), poly(methyl methacrylate) (PMMA), polypropylene carbonate (PPC), polyvinylpyrrolidone (PVP), polydimethylsiloxane (PDMS), or any combination thereof.

In some embodiments, the fourth additive 115d can make up at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, at least about 2 wt %, at least about 2.5 wt %, at least about 3 wt %, at least about 3.5 wt %, at least about 4 wt %, or at least about 4.5 wt % of the electrolyte 110. In some embodiments, the fourth additive 115d can make up no more than about 5 wt %, no more than about 4.5 wt %, no more than about 4 wt %, no more than about 3.5 wt %, no more than about 4 wt %, no more than about 2.5 wt %, no more than about 2 wt %, no more than about 1.9 wt %, no more than about 1.8 wt %, no more than about 1.7 wt %, no more than about 1.6 wt %, no more than about 1.5 wt %, no more than about 1.4 wt %, no more than about 1.3 wt %, no more than about 1.2 wt %, no more than about 1.1 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the electrolyte 110. Combinations of the above-referenced percentages are also possible (e.g., at least about 0.1 wt % and no more than about 5 wt % or at least about 1 wt % and no more than about 2 wt %), inclusive of all values and ranges therebetween. In some embodiments, the fourth additive 115d can make up about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %%, about 1.3 wt %, about 1.4 wt %, about 1.5 wt %, about 1.6 wt %, about 1.7 wt %, about 1.8 wt %, about 1.9 wt %, about 2 wt %, about 2.5 wt %, about 3 wt %, about 3.5 wt %, about 4 wt %, about 4.5 wt %, or about 5 wt % of the electrolyte 110.

In some embodiments, the fifth additive 115e can be different from the first additive 115a, the second additive 115b, the third additive 115c, and the fourth additive 115d. In some embodiments, the fifth additive 115e can include a fire retardant. In some embodiments, the fifth additive 115e can include lithium difluorophosphate (LiPO₂F₂), vinylene carbonate, fluoroethylene carbonate, difluoroethylene carbonate, bis(2,2,2-trifluoroethyl) carbonate, 1,3,2-dioxathiolan-2,2-dioxide, propene sultone, 1,2,6-oxadithiane 2,2,6,6-tetraoxide, lithium tetrafluoro(oxalato)phosphate, lithium difluoro(dioxalato)phosphate, phenylpropenenitrile, 3-cyanothiophene, trimethylsilylcarbonitrile, butanedinitrile, hexanetricarbonitrile, bis(trimethylsilyl) malonate, 1,2,3,4-tetrakis(trimethylsilyl) 1,2,3,4-butanetetracarboxylate, 1,3-bis(trimethylsilyl) 2,2-dimethylpropanedioate, trimethylsilyl 2-methyl-2-[(trimethylsilyl)oxy]propanoate, 1,4-bis(trimethylsilyl) 2-butenedioate, tris(trimethylsilyl)amine, 1,2,3-tris(trimethylsilyl) 2-[(trimethylsilyl)oxy]-1,2,3-propanetricarboxylate, 1,2,3-tris(trimethylsilyl) l-propene-1,2,3-tricarboxylate, trimethylsiloxyacetate, trially phosphate tris- (trimethylsilyl) phosphate (TMSP), tris(trimethylsilyl) phosphite (TMSPi), trioctyl phosphate (TOP), trimethoxy(3,3,3-trifluoropropyl)silane (TTS), pentafluorophenyltriethoxysilane (TPS), boric acid tris(trimethylsilyl) ester (TMSB), tris- (pentafluorophenyl)silane (TPFPS), 1,10-sulfonyldiimidazole (SDM), trioxane, lithium difluorophosphate, lithium difluoro oxalato borate, lithium nitrate, (pentafluorophenyl)diphenylphosphine (PFPDPP), cetyltrimethylammonium bromide (CTAB), sodium dodecyl sulfate (SDS), polyethylene-glycol (PEG-8000), and thiourea (TJ), benzotriazole (BTA), thiourea (CH₄N₂S), sodium dodecyl benzene sulfonate (SDBS), LiTFSI, poly(vinyl alcohol) (PVA), polyethylene glycol (PEG), carboxymethyl cellulose (CMC), an organic phosphate, lithium iron oxide, a phosphite, a phosphoramide, a substituted aliphatic phosphate, a substituted aryl phosphate, an unsubstituted aliphatic phosphate, an unsubstituted aryl phosphate, a phosphonate, a phosphoramide, a phosphazene, an inorganic phosphazene, an inorganic phosphazene, or any combination thereof. In some embodiments, the fifth additive 115e can include a polymer. In some embodiments, the fifth additive 115e can include polyvinylidene fluoride (PVDF), poly(vinylidene fluoride-hexafluoropropylene) (PVDF-HFP), polyimide (PI), CMC, poly(acrylic acid) (PAA), PEG, polyaniline (PANI) polyacrylonitrile (PAN), poly(methyl methacrylate) (PMMA), polypropylene carbonate (PPC), polyvinylpyrrolidone (PVP), polydimethylsiloxane (PDMS), or any combination thereof.

In some embodiments, the fifth additive 115e can make up at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, at least about 2 wt %, at least about 2.5 wt %, at least about 3 wt %, at least about 3.5 wt %, at least about 4 wt %, or at least about 4.5 wt % of the electrolyte 110. In some embodiments, the fifth additive 115e can make up no more than about 5 wt %, no more than about 4.5 wt %, no more than about 4 wt %, no more than about 3.5 wt %, no more than about 4 wt %, no more than about 2.5 wt %, no more than about 2 wt %, no more than about 1.9 wt %, no more than about 1.8 wt %, no more than about 1.7 wt %, no more than about 1.6 wt %, no more than about 1.5 wt %, no more than about 1.4 wt %, no more than about 1.3 wt %, no more than about 1.2 wt %, no more than about 1.1 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % of the electrolyte 110. Combinations of the above-referenced percentages are also possible (e.g., at least about 0.1 wt % and no more than about 5 wt % or at least about 1 wt % and no more than about 2 wt %), inclusive of all values and ranges therebetween. In some embodiments, the fifth additive 115e can make up about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.5 wt %, about 3 wt %, about 3.5 wt %, about 4 wt %, about 4.5 wt %, or about 5 wt % o of the electrolyte 110.

In some embodiments, the electrolyte 110 can have a conductivity of at least about 9 mS/cm, at least about 10 mS/cm, at least about 11 mS/cm, at least about 12 mS/cm, at least about 13 mS/cm, at least about 14 mS/cm, at least about 15 mS/cm, at least about 16 mS/cm, at least about 17 mS/cm, at least about 18 mS/cm, at least about 19 mS/cm, at least about 20 mS/cm, at least about 21 mS/cm, at least about 22 mS/cm, at least about 23 mS/cm, at least about 24 mS/cm, or at least about 25 mS/cm.

In some embodiments, the electrolyte 110 can show a peak shift in Raman spectroscopy (e.g., a blue shift of an FSI peak). In some embodiments, the electrolyte 110 can exhibit a shift in reduction potential of FEC in a cyclic voltammetry scan.

In some embodiments, the electrolyte 110 can have a transference number that increases upon mixing between the first electrolyte solvent 112a, the second electrolyte solvent 112b, the third electrolyte solvent 112c, the fourth electrolyte solvent 112d, and/or the fifth electrolyte solvent 112e. In other words, the transference number increases when the solvent package changes. In some embodiments, the transference number can increase by at least about 0.05, at least about 0.1, at least about 0.15, at least about 0.2, at least about 0.25, at least about 0.3, at least about 0.35, at least about 0.4, at least about 0.45, or at least about 0.5 when the solvent package changes. In some embodiments, the transference number can increase by no more than about 0.5, no more than about 0.45, no more than about 0.4, no more than about 0.35, no more than about 0.3, no more than about 0.25, no more than about 0.2, no more than about 0.15, or no more than about 0.1 when the solvent package changes. Combinations of the above-referenced increase values are also possible (e.g., at least about 0.05 and no more than about 0.5 or at least about 0.15 and no more than about 0.35), inclusive of all values and ranges therebetween. In some embodiments, the transference number can increase by about 0.05, about 0.1, about 0.15, about 0.2, about 0.25, about 0.3, about 0.35, about 0.4, about 0.45, or about 0.5 when the solvent package changes. In some embodiments, the transference number can be determined via the Bruce-Vincent method, the Hittorf method, or any combination thereof.

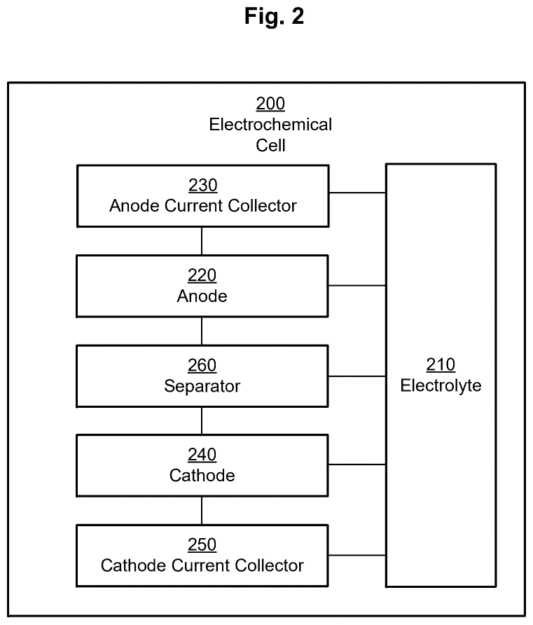

FIG. 2 is a block diagram of an electrochemical cell 200, according to an embodiment. As shown, the electrochemical cell 200 includes an electrolyte 210, an anode 220 disposed on an anode current collector 230, a cathode 240 disposed on a cathode current collector 250, and a separator 260 disposed between the anode 220 and the cathode 240. In some embodiments, the electrolyte 210 can be the same or substantially similar to the electrolyte 110, as described above with respect to FIG. 1. Thus, certain aspects of the electrolyte 210 are not described in greater detail herein.

In some embodiments, the anode 220 and/or the cathode 240 can include a metal-oxide such as LiCoO₂ (lithium cobalt oxide, LCO), Li(Ni, Mn, Co)O₂ (lithium nickel manganese cobalt oxide, NMC, which is also referred to as NCM), LiNi_{0.8}Co_{0.15}Al_{0.05}O₂ (lithium nickel cobalt aluminum oxide, NCA), a spinel structure, LiMn₂O₄ (lithium manganese oxide, LMO, where M is a metal), an olivine structure (LiMPO₄, where M is a metal), LiCoPO₄ (lithium cobalt phosphate, LCP), LiNiPO₄ (lithium nickel phosphate, LNP), LiFePO₄ (lithium iron phosphate, LFP), LiMnPO₄ (lithium manganese phosphate, LMP), LiMn_{0.85}Fe_{0.15}PO₄ (lithium manganese iron phosphate, LMFP), and/or Li₄Tr₅O₁₂ (lithium titanate, LTO). In some embodiments, the anode 220 and/or the cathode 240 can include sulfur, Li₂S, SeS₂, and sulfurized polyacrylonitrile, O₂, Li₂O, Li₂O₂, FeF₃, V₂O₅, BiF₃, FeS₂, or any combination thereof.

In some embodiments, lithium can be replaced with sodium in any of the aforementioned electrode materials. In some embodiments, the anode 220 and/or the cathode 240 can include a metal-oxide such as NaCoO₂ (sodium cobalt oxide), Na(Ni, Mn, Co)O₂ (sodium nickel manganese cobalt oxide), NaNi_{0.8}Co_{0.15}Al_{0.05}O₂ (sodium nickel cobalt aluminum oxide), a spinel structure, NaMn₂O₄ (sodium manganese oxide), an olivine structure (NaMPO₄, where M is a metal), NaCoPO₄ (sodium cobalt phosphate), NaNiPO₄ (sodium nickel phosphate), NaFePO₄ (sodium iron phosphate), NaMnPO₄ (sodium manganese phosphate), NaMn_{0.85}Fe_{0.15}PO₄ (sodium manganese iron phosphate), and/or Na₄Ti₅O₁₂ (sodium titanate). In some embodiments, the anode 220 and/or the cathode 240 can include sodium manganese oxide, sodium vanadium oxide, sodium sulfur compounds, and/or Prussian blue/white analogues.

In some embodiments, lithium can be replaced with potassium in any of the aforementioned electrode materials. In some embodiments, the anode 220 and/or the cathode 240 can include a metal-oxide such as KCoO₂ (potassium cobalt oxide), K(Ni, Mn, Co)O₂ (potassium nickel manganese cobalt oxide, KNMC), KNi_{0.8}Co_{0.15}Al_{0.05}O₂ (potassium nickel cobalt aluminum oxide), a spinel structure, KMn₂O₄ (potassium manganese oxide), an olivine structure (KMPO₄, where M is a metal), KCoPO₄ (potassium cobalt phosphate). KNiPO₄ (potassium nickel phosphate), KFePO₄ (potassium iron phosphate), KMnPO₄ (potassium manganese phosphate), KMn_{0.85}Fe_{0.15}PO₄ (potassium manganese iron phosphate), and/or K₄Ti₅O₁₂ (potassium titanate). In some embodiments, the anode 220 and/or the cathode 240 can include potassium cobalt oxide (KCO), potassium vanadium oxide, or any combination thereof.

In some embodiments, the anode 220 can include an intercalation based anode material. In some embodiments, the anode 220 can include carbon, graphite, hard carbon, activated carbon, silicon, SiO, Sn, SnS, SnS₂, Sn₃P₄, Sb, SbS, Bi, P, TiO₂, LTO, or any combination thereof. In some embodiments, the anode 220 includes pure lithium metal. In some embodiments, the anode 220 may include graphite. In some embodiments the cathode 240 may include LFP and/or KETJENBLACK® conductive carbon (KB). In some embodiments, the cathode 240 may include high-nickel layered oxide (NMC811). In some embodiments, the cathode 240 may include about 55 vol % LFP and about 0.3 vol % KB. In some embodiments, the cathode 240 may include about 45 vol % NMC811 and about 2 vol % KB. In some embodiments, the anode 220 can include an alloy-based anode. In some embodiments, the alloy-based anode can include silicon, SiO, antimony, tin, aluminum, silver, and/or copper. In some embodiments, the anode 220 can include a conversion anode. In some embodiments, the conversion anode can include zinc oxide (ZnO), zinc, copper oxide (Cu₂O), lithium titanate (LTO), titanium (IV) oxide (TiO₂), or any combination thereof.

In some embodiments, the anode 220 can include silicon, tin, antimony, lead, silicon oxide, SiOₓ (where x=0.5-2 (i.e., 0.5, 1, or 2)), graphite, carbon nanotubes (CNT), graphene, a silicon/graphite composite, a SiOₓ/graphite composite (where x=0.5-2 (i.e., 0.5, 1, or 2)), a silicon/graphite/lithium composite, or a SiOₓ/graphite/lithium composite (where x=0.5-2 (i.e., 0.5, 1, or 2)), tin oxide, antimonic oxide, lead oxide, a tin/graphite composite, a tin oxide/graphite composite, a tin/graphite/lithium composite, a tin oxide/graphite/lithium composite, an antimony/graphite composite, an antimonic oxide/graphite composite, an antimony/graphite/lithium composite, an antimonic oxide/graphite/lithium composite, a lead/graphite composite, a lead oxide/graphite composite, a lead/graphite/lithium composite, a lead oxide/graphite/lithium composite, a silicon/CNT composite, a SiOₓ/CNT composite (where x=0.5-2 (i.e., 0.5, 1, or 2)), a silicon/CNT/lithium composite, or a SiOₓ/CNT/lithium composite (where x=1 or 2), a tin/CNT composite, a tin oxide/CNT composite, a tin/CNT/lithium composite, a tin oxide/CNT/lithium composite, an antimony/CNT composite, an antimonic oxide/CNT composite, an antimony/CNT/lithium composite, an antimonic oxide/CNT/lithium composite, a lead/CNT composite, a lead oxide/CNT composite, a lead/CNT/lithium composite, a lead oxide/CNT/lithium composite, a silicon/graphene composite, a SiOₓ/graphene composite (where x=0.5-2 (i.e., 0.5, 1, or 2)), a silicon/graphene/lithium composite, or a SiOₓ/graphene/lithium composite (where x=0.5-2 (i.e., 0.5, 1, or 2)), a tin/graphene composite, a tin oxide/graphene composite, a tin/graphene/lithium composite, a tin oxide/graphene/lithium composite, an antimony/graphene composite, an antimonic oxide/graphene composite, an antimony/graphene/lithium composite, an antimonic oxide/graphene/lithium composite, a lead/graphene composite, a lead oxide/graphene composite, a lead/graphene/lithium composite, and/or a lead oxide/graphene/lithium composite.

In some embodiments, the anode 220 can include a composite that includes a metal or a metal oxide (e.g., silicon, SiOₓ) with a carbon-containing material (e.g., graphite). In some embodiments, the metal and/or the metal oxide can make up at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, at least about 50 wt %, at least about 51 wt %, at least about 52 wt %, at least about 53 wt %, at least about 54 wt %, at least about 55 wt %, at least about 56 wt %, at least about 57 wt %, at least about 58 wt %, or at least about 59 wt % of the composite.

In some embodiments, the metal and/or the metal oxide can make up no more than about 60 wt %, no more than about 59 wt %, no more than about 58 wt %, no more than about 57 wt %, no more than about 56 wt %, no more than about 55 wt %, no more than about 54 wt %, no more than about 53 wt %, no more than about 52 wt %, no more than about 51 wt %, no more than about 50 wt %, no more than about 49 wt %, no more than about 48 wt %, no more than about 47 wt %, no more than about 46 wt %, no more than about 45 wt %, no more than about 44 wt %, no more than about 43 wt %, no more than about 42 wt %, no more than about 41 wt %, no more than about 40 wt %, no more than about 39 wt %, no more than about 38 wt, no more than about 37 wt %, no more than about 36 wt %, no more than about 35 wt %, no more than about 34 wt %, no more than about 33 wt %, no more than about 32 wt %, no more than about 31 wt %, no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, or no more than about 2 wt % of the composite.

Combinations of the above-referenced weight percentages are also possible (e.g., at least about 1 wt % and no more than about 60 wt % or at least about 18 wt % and no more than about 36 wt %), inclusive of all values and ranges therebetween. In some embodiments, the metal and/or the metal oxide can make up about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, or about 60 wt % of the composite.

In some embodiments, the anode 220 can include a pure metal in a composite (e.g., lithium/graphite composite). In some embodiments, the pure metal can make up at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt % of the composite.

In some embodiments, the pure metal can make up no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, or no more than about 2 wt % of the composite. Combinations of the above-referenced percentages are also possible (e.g., at least about 1 wt % and no more than about 30 wt % or at least about 5 wt % and no more than about 20 wt %), inclusive of all values and ranges therebetween. In some embodiments, the pure metal can make up about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the composite.

In some embodiments, the anode 220 can include a metal silicide, nickel silicide, cobalt silicide, copper silicide, silver silicide, chromium silicide, titanium silicide, aluminum silicide, zinc silicide, and/or iron silicide. In some embodiments, the anode 220 can include a non-silicide electrode. In some embodiments, the anode 220 can include crystalline silicon, amorphous silicon, silicon oxides, silicon oxy-nitrides, tin-containing material, and/or germanium-containing material. In some embodiments, the anode 220 can include doped non-silicide with dopants from group 3 and/or group 5 elements.

In some embodiments, the anode 220 can include active materials that include at least one of a metal, a metal oxide, a metal sulfide, or a metal phosphide that is active towards alloying reaction and/or conversion reaction with Li, Na, and/or K. In some embodiments, the anode 220 can include Sn, Sb, Ag, Bi, Pb, Se, S, Al, In, Te, Au, Ti, Fe, Co, Ni, Cu, Zn, V, Cr, Ca, Ge, and/or W.

In some embodiments, the anode 220 can include a non-silicide and carbonaceous phase, the non-silicide phase and carbonaceous phase including graphite, hard carbon, soft carbon, amorphous carbon, nanostructured carbon, or any combination thereof.

In some embodiments, the active material in the anode 220 can have a capacity of at least about 300 mAh/g, at least about 400 mAh/g, at least about 500 mAh/g, at least about 600 mAh/g, at least about 700 mAh/g, at least about 800 mAh/g, at least about 900 mAh/g, at least about 1,000 mAh/g, at least about 1,500 mAh/g, at least about 2,000 mAh/g, at least about 2,500 mAh/g, at least about 3,000 mAh/g, or at least about 3,500 mAh/g. In some embodiments, the active material in the anode 220 can have a capacity of no more than about 4,000 mAh/g, no more than about 3,500 mAh/g, no more than about 3,000 mAh/g, no more than about 2,500 mAh/g, no more than about 2,000 mAh/g, no more than about 1,500 mAh/g, no more than about 1,000 mAh/g, no more than about 900 mAh/g, no more than about 800 mAh/g, no more than about 700 mAh/g, no more than about 600 mAh/g, no more than about 500 mAh/g, or no more than about 400 mAh/g. Combinations of the above-referenced capacities are also possible (e.g., at least about 300 mAh/g and no more than about 4,000 mAh/g or at least about 500 mAh/g and no more than about 2 mAh/g), inclusive of all values and ranges therebetween. In some embodiments, the active material in the anode 220 can have a capacity of about 300 mAh/g, about 400 mAh/g, about 500 mAh/g, about 600 mAh/g, about 700 mAh/g, about 800 mAh/g, about 900 mAh/g, about 1,000 mAh/g, about 1,500 mAh/g, about 2,000 mAh/g, about 2,500 mAh/g, about 3,000 mAh/g, about 3,500 mAh/g, or about 4,000 mAh/g.

In some embodiments, the active material in the anode 220 can have a porosity of at least about 0%, at least about 5%, at least about 10%, at least about 15%, at least about 20%, at least about 25%, at least about 30%, at least about 35%, at least about 40%, or at least about 45%. In some embodiments, the active material in the anode 220 can have a porosity of no more than about 50%, no more than about 45%, no more than about 40%, no more than about 35%, no more than about 30%, no more than about 25%, no more than about 20%, no more than about 15%, no more than about 10%, or no more than about 5%. Combinations of the above-referenced porosities are also possible (e.g., at least about 0% and no more than about 50% or at least about 10% and no more than about 40%), inclusive of all values and ranges therebetween. In some embodiments, the active material in the anode 220 can have a porosity of about 0%, about 5%, about 10%, about 15%, about 20%, about 25%, about 30%, about 35%, about 40%, about 45%, or about 50%.

In some embodiments, the cathode 240 can include a lithium ion chemistry. In some embodiments, the cathode 240 can include lithium nickel manganese cobalt oxide (NMC), an NMC derivative, lithium iron phosphate (LFP), an LFP derivative, a conversion-based anode, sulfur, a sulfur derivative, a metal fluoride. CuF₂, FeF₂, Fe₂F₃, and/or LiO₂. In some embodiments, the cathode 240 can include a sodium ion chemistry. In some embodiments, the cathode 240 can include a potassium ion chemistry.

In some embodiments, the electrochemical cell 200 can have several performance-based advantages. In some embodiments, the electrochemical cell 200 can retain at least about 80%, at least about 81%, at least about 82%, at least about 83%, at least about 84%, at least about 85%, at least about 86%, at least about 87%, at least about 88%, at least about 89 wt %, at least about 90%, at least about 91%, at least about 92%, at least about 93%, at least about 94%, at least about 95%, at least about 96%, at least about 97%, at least about 98%, or at least about 99 wt % of its capacity after a 10C fast charge, inclusive of all values and ranges therebetween. In some embodiments, the electrochemical cell 200 can retain at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, or at least about 95% of its capacity after a 5C fast charge, inclusive of all values and ranges therebetween. In some embodiments, the electrochemical cell 200 can retain at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, or at least about 90% of its capacity after a 20C fast charge, inclusive of all values and ranges therebetween.

In some embodiments, the electrochemical cell 200 can retain at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, at least about 99.9% or about 100% of its capacity with a 5C charge/1C discharge over 200 cycles, inclusive of all values and ranges therebetween.

In some embodiments, the electrochemical cell 200 can retain at least about 85%, at least about 86%, at least about 87%, at least about 88%, at least about 89%, at least about 90%, at least about 91%, at least about 92%, at least about 93%, at least about 94%, or at least about 95% of its room temperature capacity at −20° C., inclusive of all values and ranges therebetween.

In some embodiments, the separator 260 can be replaced with a solid-state electrolyte material. In some embodiments, a solid-state electrolyte material can be included in the electrochemical cell 200 in addition to the separator 260. In some embodiments, the solid-state electrolyte material can be coupled to the separator 260. In some embodiments, the solid-state electrolyte material can act as the main ion conductive component in the anode 220 and/or the cathode 240. In some embodiments, the anode 220 and/or the cathode 240 can be composed of at least about 50 vol %, at least about 60 vol %, at least about 70 vol %, or at least about 80 vol % solid-state electrolyte. In some embodiments with solid-state electrolyte s, the electrolyte 210 can act as a bridging agent between the solid-state electrolyte and active material (e.g., NMC).

In some embodiments, the solid-state electrolyte material can include a Lithium Super Ionic Conductor (LISICON) structure, a glass structure such as La_{0.51}Ti_{0.34}O_{2.94}, Li_{1.3}Al_{0.3}Ti_{1.7}(PO₄)₃ (LATP), Li_{1.3}Al_{0.3}Ti_{1.7}(PO₄)₃, Li_{1.4}Al_{0.4}Ti_{1.16}(PO₄)₃, Li₇La₃Zr₂O₁₂, Li_{6.66}La₃Zr_{1.6} Ta_{0.4}O_{12.9} (LLZO), 50Li₄SiO₄·50Li₃BO₃, Li_{2.9}PO_{3.3}N_{0.46} (lithium phosphorousoxynitride, LiPON), Li_{3.6}Si_{0.6}P_{0.4}O₄, Li₃BN₂, Li₃BO₃—Li₂SO₄, Li₃BO₃—Li₂SO₄—Li₂CO₃ (LIBSCO, pseudoternary system), and/or sulfide contained solid-state electrolyte including a thio-LISICON structure, a glassy structure and/or a glass-ceramic structure such as Li_{1.07}Al_{0.69}Ti_{1.46} (PO₄)₃, Li_{1.5}Al_{0.5}Ge_{1.5}(PO₄)₃, Li₁₀GeP₂S₁₂ (LGPS), 30Li₂S·26B₂S₃·44LiI, 63Li₂S·36SiS₂·1Li₃PO₄, 57Li₂S·38SiS₂·5Li₄SiO₄, 70Li₂S·30P₂S₅, 50Li₂S·50GeS₂, Li₇P₃S₁₁, Li_{3.25}P_{0.95}S₄, and Li_{9.54}Si_{1.74}P_{1.44}S_{11.7}C_{10.3}, and/or closo-type complex hydride solid-state electrolyte such as LiBH₄—LiI, LiBH₄—LiNH₂, LiBH₄—P₂S₅, Li(CBₓHₓ₊₁)—LiI (where x is an integer) like Li(CB₉H₁₀)—LiI; phosphate sulfide-based electrolytes, including lithium phosphorus sulfide (LPS), Li₁₀GeP₂S₁₂ (LGPS), lithium tin phosphorus sulfide (LSPS), and/or Li_{5.5}PS_{4.5}Cl_{1.5} (LPSCI) and/or lithium argyrodite Li₆PS₅X (X=Cl, Br) and/or halide electrolytes Li₃₋ₓM₁₋ₓX₆ (M=Y, Er, In, Yb, Ho, X=Cl, Br, I, F), or any combination thereof.

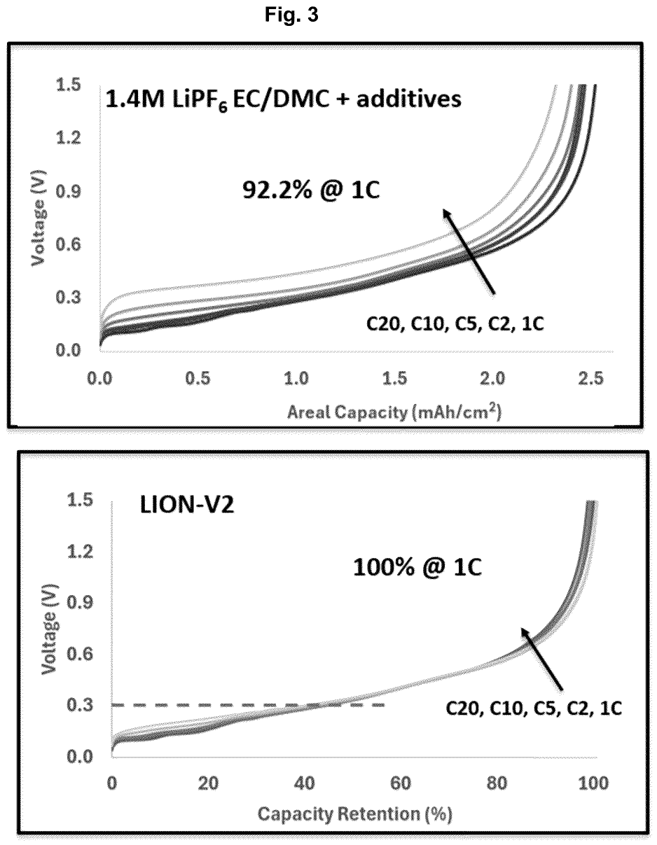

FIG. 3 is a graphical representation of voltage curves of electrochemical cells including electrolytes described herein. As shown on the left, a LiPF₆ salt is dissolved in EC/DMC at 1.4M with additives to form an electrolyte. The electrolyte is incorporated into an electrochemical cell with a silicon/graphite composite anode. In the image on the right, a dual-salt electrolyte is used, which includes LiPF₆ and LiFSI in a fluoroether and additional solvents. As shown, the electrochemical cell with the dual salt electrolyte retains more capacity when charging at higher charge rates. Additionally, the electrochemical cell with the dual salt electrolyte retains more capacity when charging at 1C.

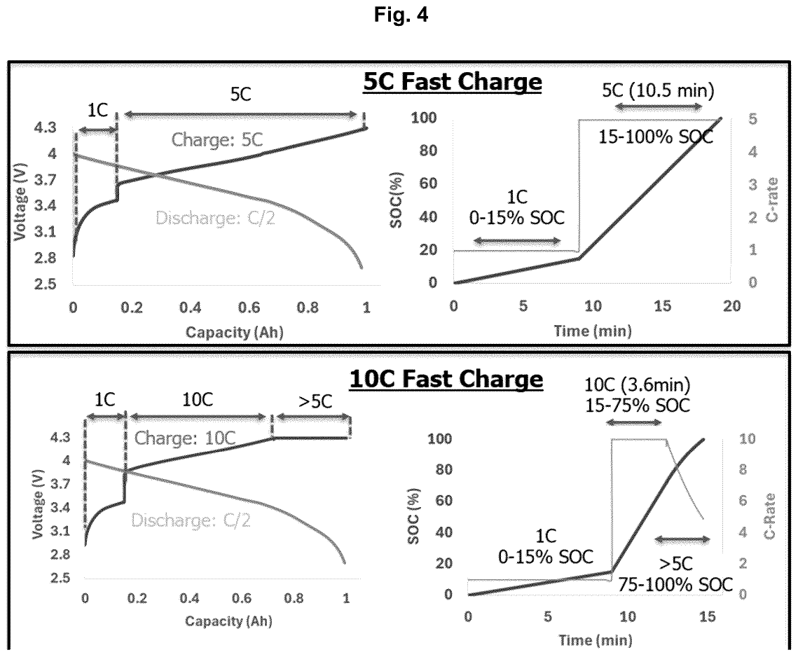

FIG. 4 is a graphical representation of voltage curves and state of charge (SOC) curves of electrochemical cells including electrolytes described herein. As shown, a Si-Gr/NMC811 cell was used with different electrolytes. At a 5C continuous charge rate with a more conventional electrolyte, the electrochemical cell charges 15-100% SOC in about 10.5 minutes. At 10C continuous charge rate, the electrochemical cell with the dual-salt electrolyte with LiPF₆ and LiFSI in a fluoroether and additional solvents (conductivity of about 25 mS/cm) enables charge from 15-75% SOC in about 3.6 minutes and 15-100% SOC in about 5.7 minutes.

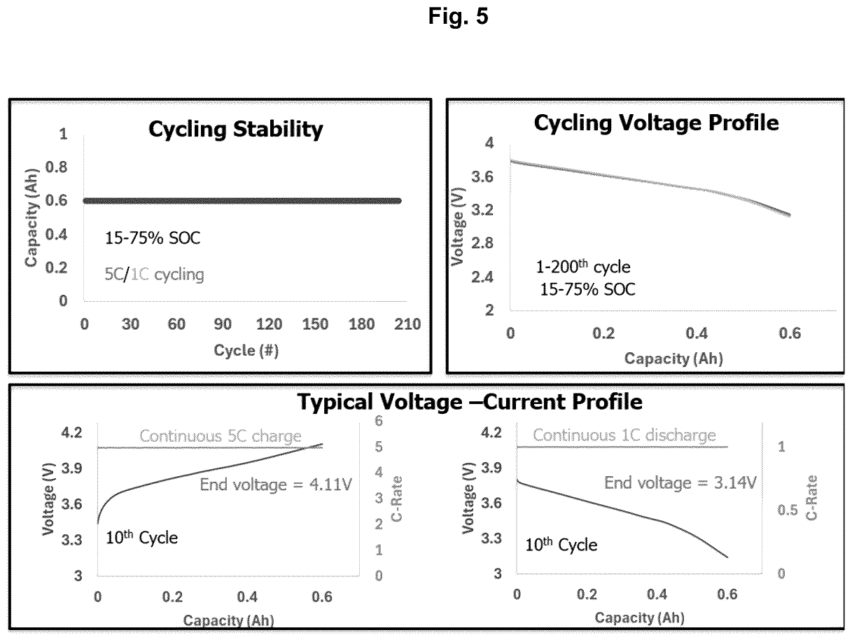

FIG. 5 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 35° C. As shown, stable cycling can be achieved with a continuous 5C charge and 1C discharge rate within 15-75% SOC. Negligible polarization was observed, indicating a stable electrolyte-electrode interface.

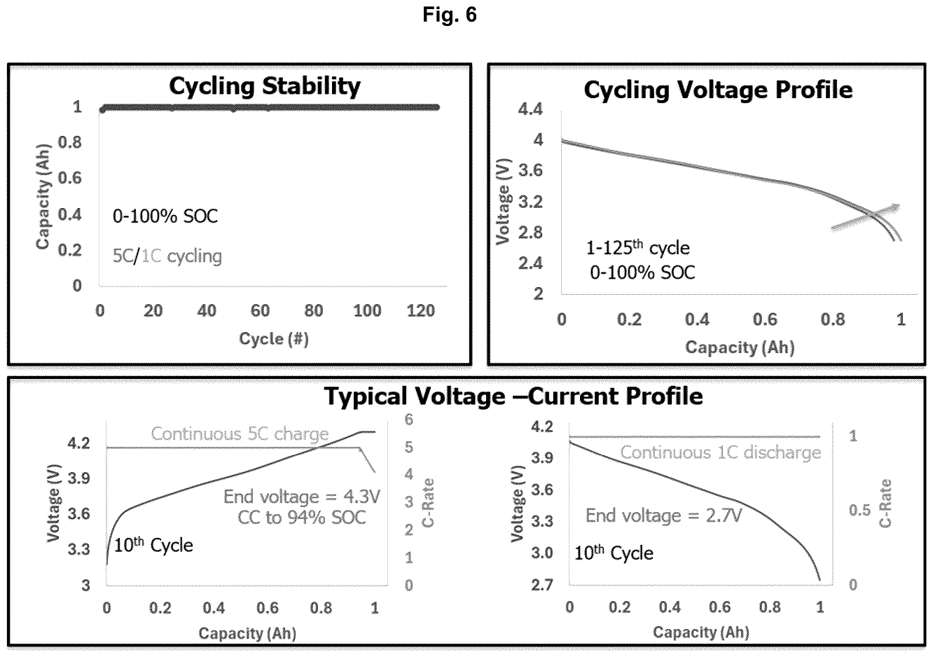

FIG. 6 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. As shown, stable cycling can be achieved with a continuous 5C charge and 1C discharge rate within 0-100% SOC. A constant current can be maintained up to 94% of SOC.

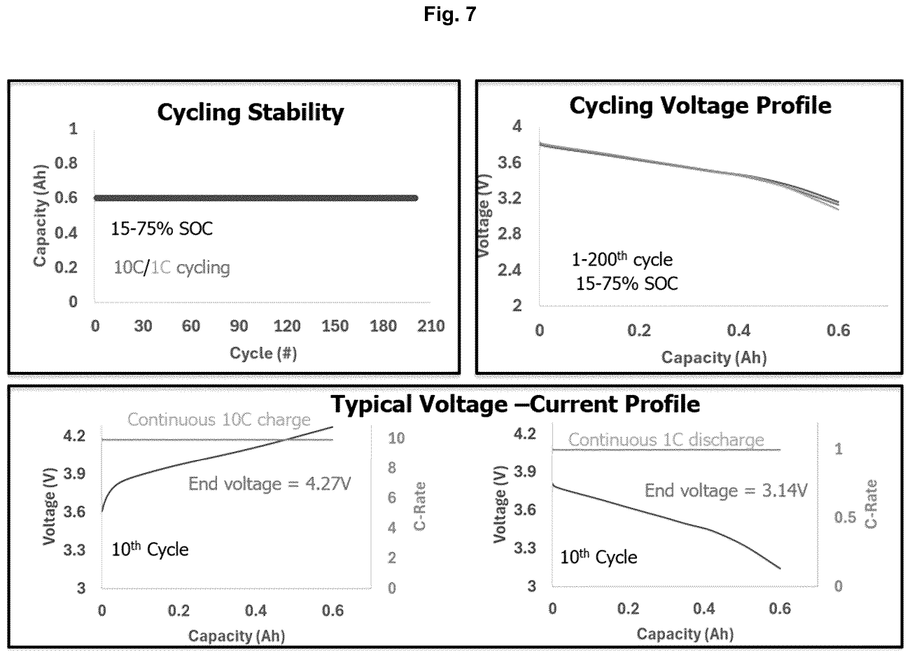

FIG. 7 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. As shown, stable cycling can be achieved with a continuous 10C charge and 1C discharge rate within 15-75% SOC. A cutoff voltage is less than 4.3 V at the end of a constant current charge and there is negligible polarization from cycling.

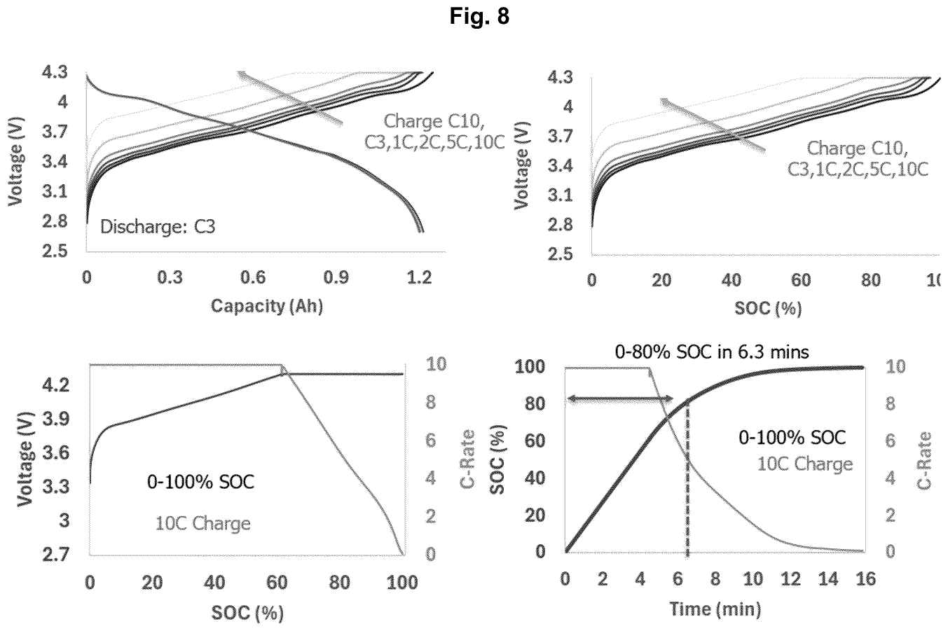

FIG. 8 is a graphical representation of voltage curves and SOC curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. The electrochemical cell shows up to 97.5% capacity unitization at a 10C charge rate. High-rate charging has a negligible effect on discharge capacity. The electrochemical cell takes about 6.3 minutes to go from 0 to 80% SOC at a 10C charge rate. As shown, the electrochemical cell charges from 0-100% at 10C charge rate in less than 16 minutes and retains up to 97.5% capacity unitization at 10C charge rate.

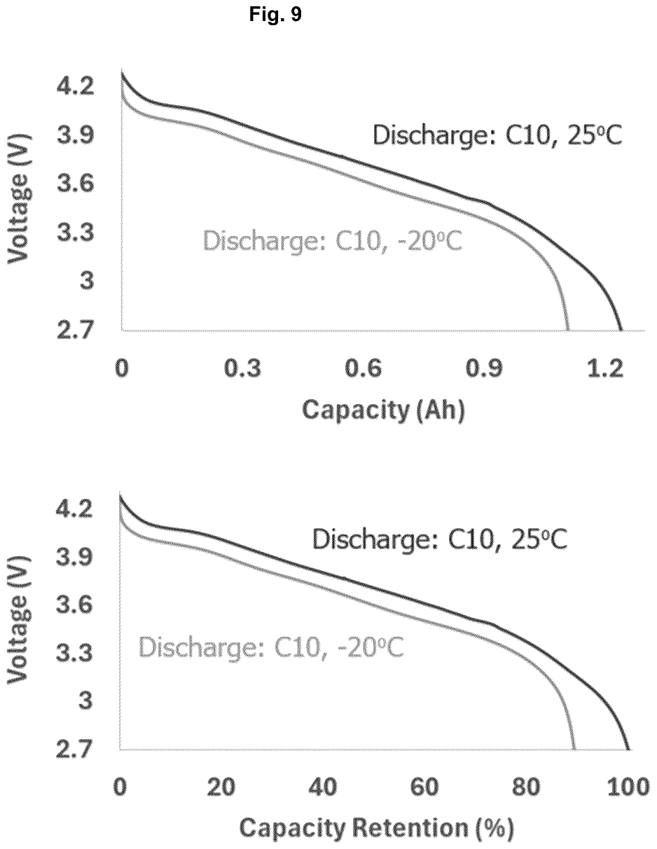

FIG. 9 is a graphical representation of voltage curves of electrochemical cells including electrolytes described herein. As shown, a Si-Gr/NMC811 cell was used, having a dual-salt electrolyte with LiPF₆ and LiFSI in a fluoroether and additional solvents. Charging was done at 25° C. and discharging was done at −20° C. As shown, the electrochemical cells retain 90% of their capacity when discharging at −20° C.

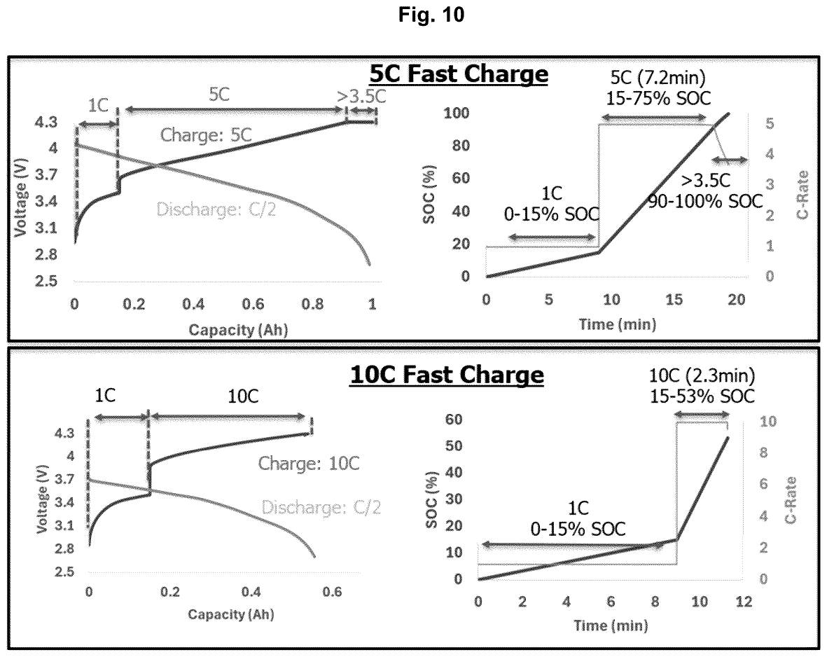

FIG. 10 is a graphical representation of voltage curves and SOC curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. At a 5C continuous charge rate, the electrochemical cell charges from 15 to 75% SOC in 7.2 minutes. At a 10C continuous charge rate, the electrochemical cell charges from 15 to 53% SOC in 2.3 minutes.

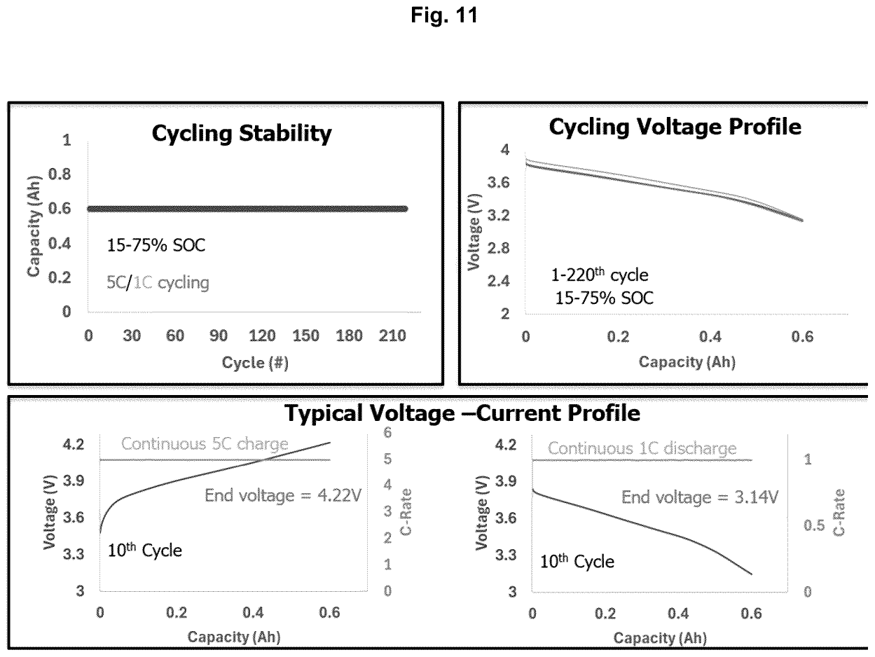

FIG. 11 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 35° C. A stable cycling was achieved with a continuous 5C charge and 1C discharge rate within 15 and 75% SOC. Negligible polarization was observed, indicating a stable electrolyte-electrode interface.

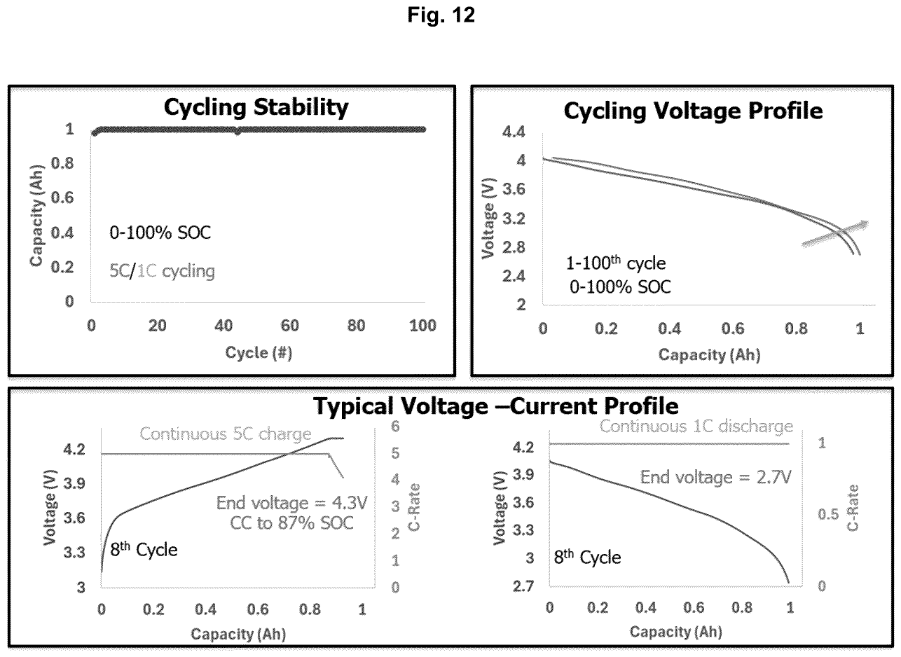

FIG. 12 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 35° C. A stable cycling was achieved with continuous 5C charging and 1C discharging within 0 to 100% SOC. A constant current charge was maintained up to 87% of SOC.

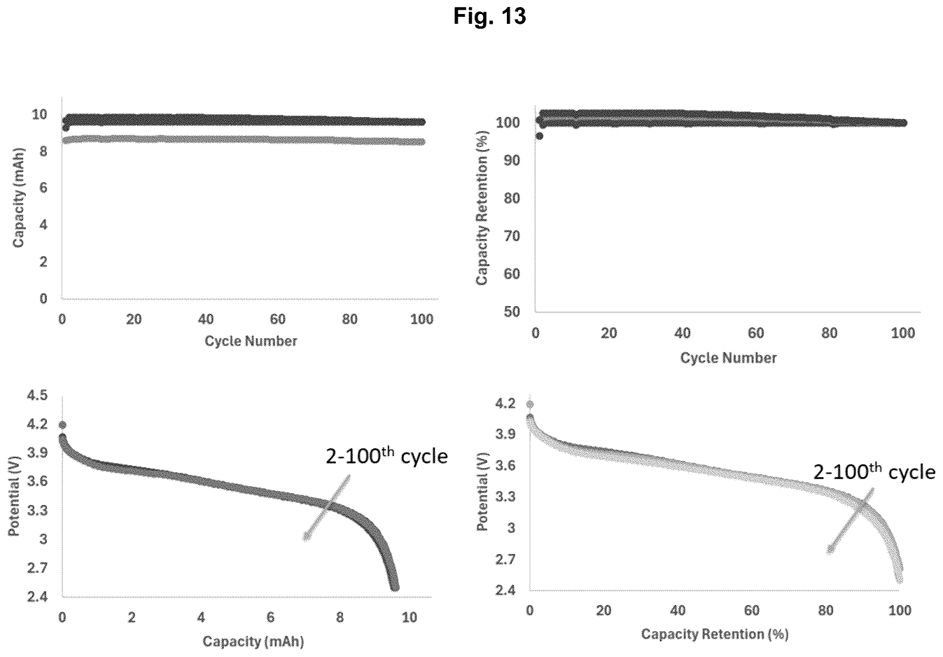

FIG. 13 is a graphical representation of voltage curves and capacity retention curves of electrochemical cells including electrolytes described herein. As shown, a NMC811 cell was used, having a 50 μm lithium anode, a 12 μm ENTEK® separator, and a dual-salt electrolyte with LiPF₆ and LiFSI in a fluoroether and additional solvents. Cycling was done at 30° C. Negligible capacity fade was seen over 100 cycles while charging at 5C and discharging at 20C.

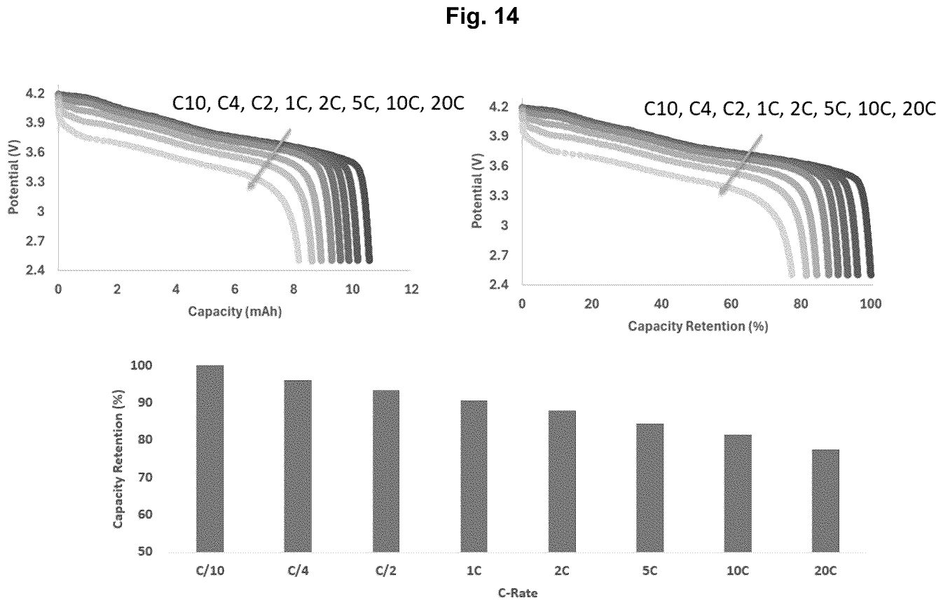

FIG. 14 is a graphical representation of voltage curves and capacity retention rates of electrochemical cells including electrolytes described herein. As shown, a NMC811 cell was used, having a 50 μm lithium anode, a 12 μm ENTEK® separator, and a dual-salt electrolyte with LiPF₆ and LiFSI in a fluoroether and additional solvents. Ultra-high continuous discharge performance was observed with >84%, 81%, and 77% capacity retention at 5C, 1° C., and 20C, respectively (power density of 3,900 W/kg).

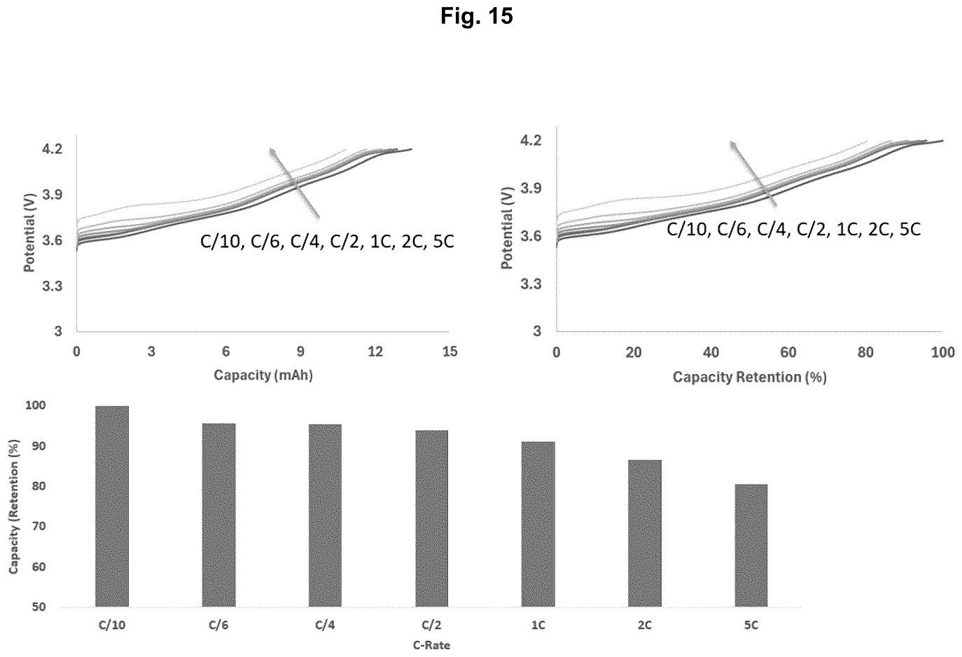

FIG. 15 is a graphical representation of voltage curves and capacity retention rates of electrochemical cells including electrolytes described herein. As shown, a NMC811 cell was used, having a 50 μm lithium anode, a 12 μm ENTEK® separator, and a dual-salt electrolyte with LiPF₆ and LiFSI in a fluoroether and additional solvents. Ultra-high continuous charge performance with ~80% capacity utilization within 11 minutes at 5C was observed (power density of 975 W/kg).

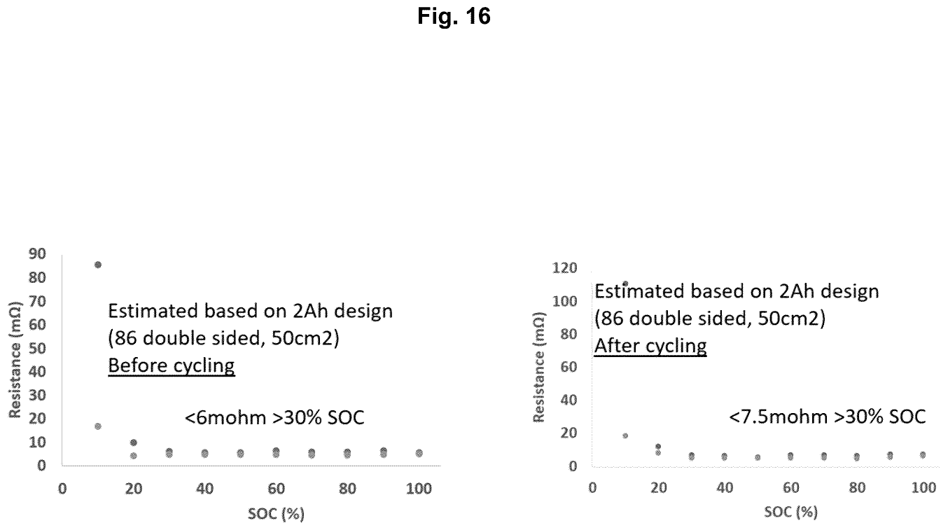

FIG. 16 is a graphical representation of resistance vs. SOC curves of electrochemical cells including electrolytes described herein. As shown, a NMC811 cell was used, having a 50 μm lithium anode, a 12 μm ENTEK® separator, and a dual-salt electrolyte with LiPF₆ and LiFSI in a fluoroether and additional solvents. The plot on the left is before cycling, while the plot on the right is after cycling. Resistance is measured to be <6 ma at >30% SOC before charging and <7.5 mΩ at >30% SOC after charging.

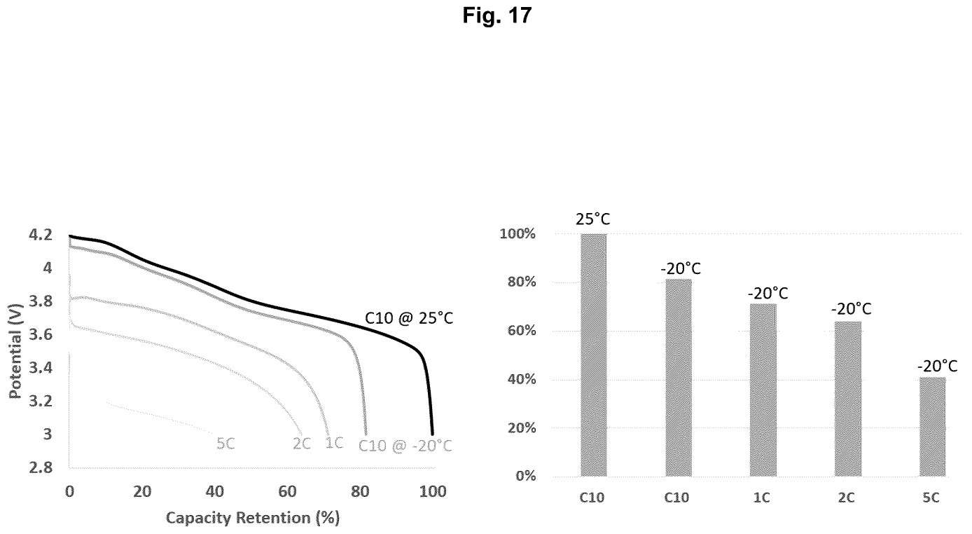

FIG. 17 is a graphical representation of capacity retention of electrochemical cells including electrolytes described herein. As shown, a NMC811 cell was used, having a 50 μm lithium anode, a 12 μm ENTEK® separator, and a dual-salt electrolyte with LiPF₆ and LiFSI in a fluoroether and additional solvents. The electrochemical cell was discharged at −20° C. at various rates. As shown, the electrochemical cell retained about 85% of its capacity when discharging at C/10 at −20° C.

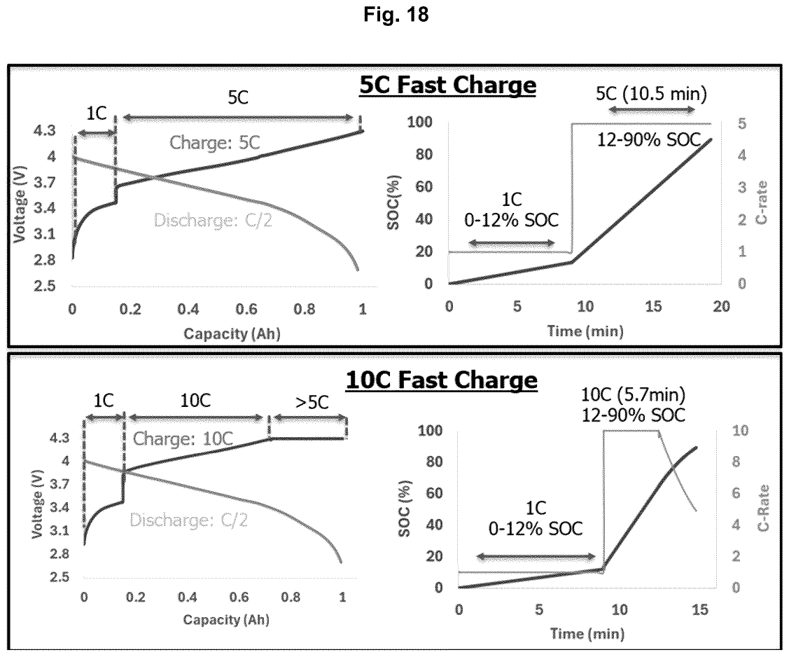

FIG. 18 is a graphical representation of voltage curves and SOC curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 35° C. At a 5C continuous charge rate, the electrochemical cell charges from 12 to 90% SOC in 10.5 minutes. At a 10C continuous charge rate, the electrochemical cell charges from 12 to 62% SOC in 3.6 minutes or 12 to 90% SOC in 5.7 minutes.

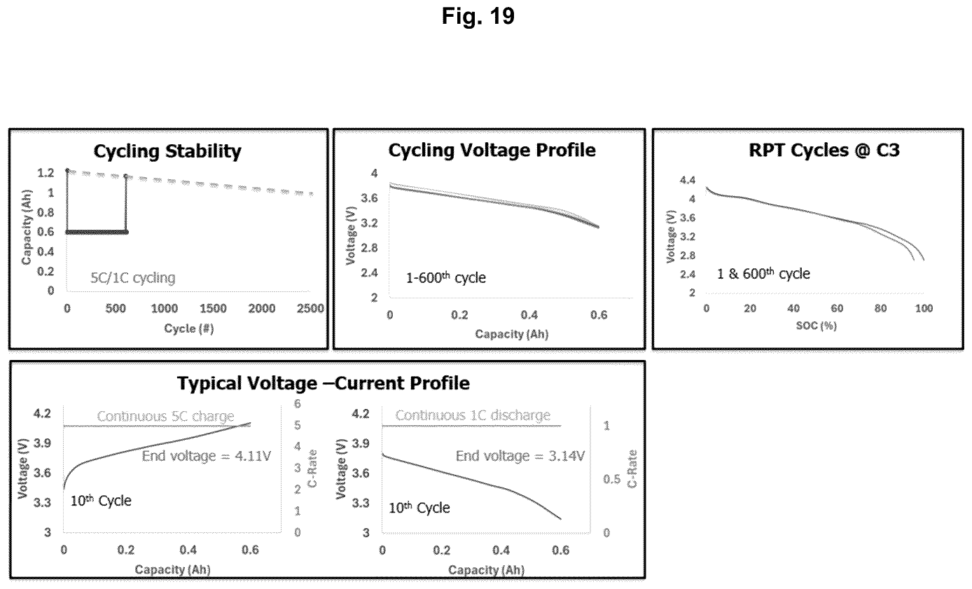

FIG. 19 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 35° C. Stable cycling was achieved with 5C/1C charge/discharge 50% depth of discharge (DoD) cycling. An estimated 2,500 cycles were executed with 80% capacity retention.

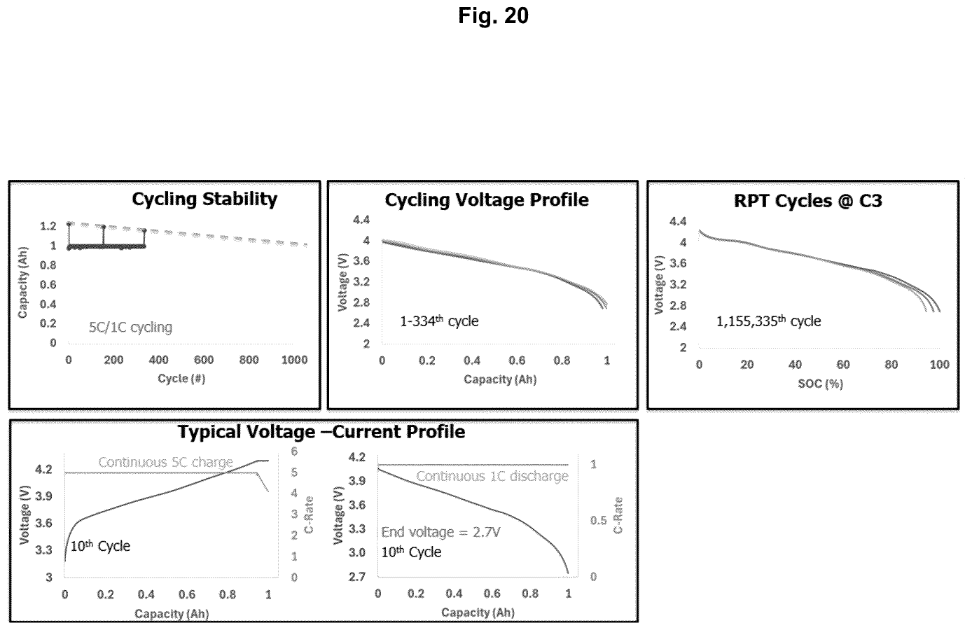

FIG. 20 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 35° C. Stable cycling was achieved with 5C/1C charge/discharge 90% DoD cycling. An estimated 1,100 cycles were executed with 80% capacity retention.

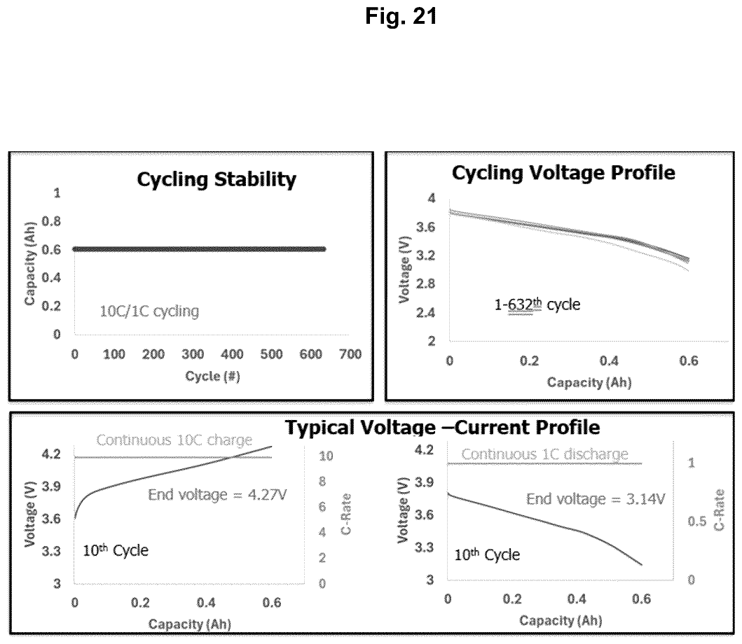

FIG. 21 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 35° C. Greater than 630 stable cycles were achieved with 5C/1C charge/discharge 50% DoD cycling. Cut off voltage was less than 4.3 at the end of constant current charge and there was negligible polarization from cycling.

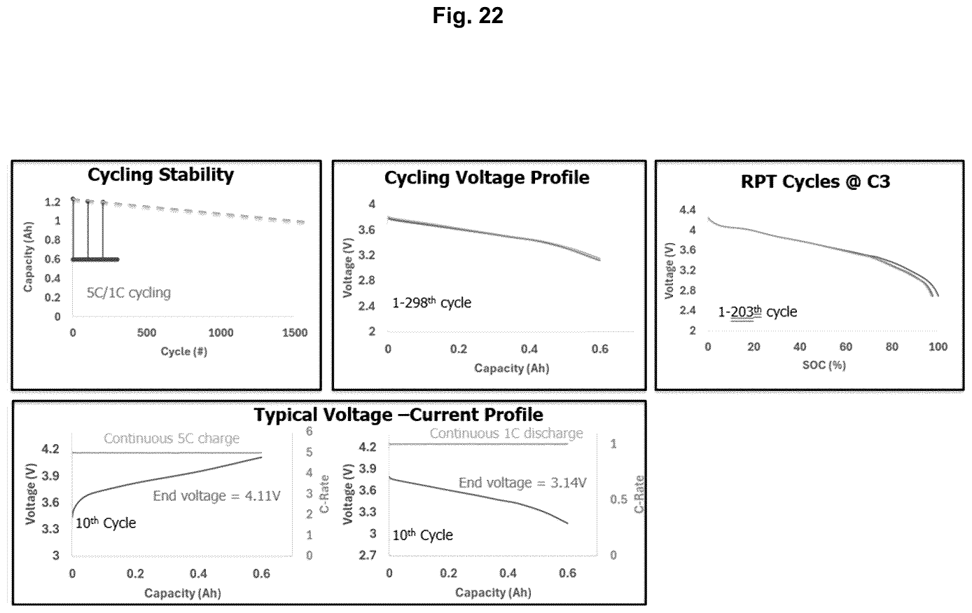

FIG. 22 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. Stable cycling was achieved with 5C/1C charge/discharge 50% DoD cycling. An estimated 1,500 cycles were executed with 80% capacity retention.

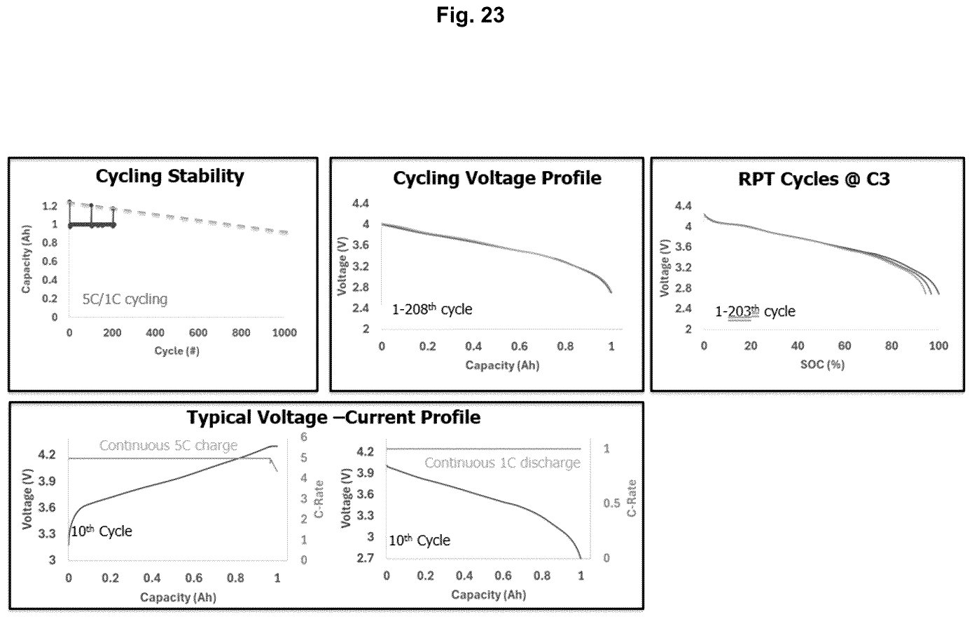

FIG. 23 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. Stable cycling was achieved with 5C/1C charge/discharge 90% DoD cycling. An estimated 7,500 cycles were executed with 80% capacity retention.

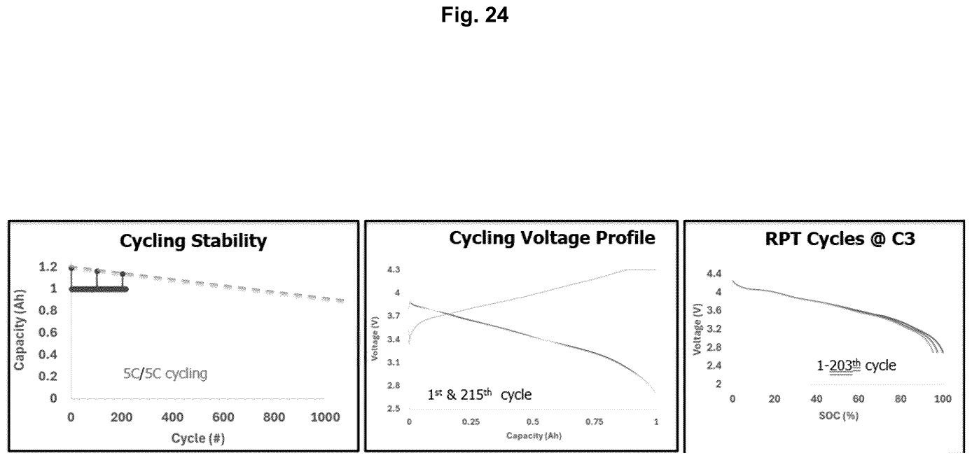

FIG. 24 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. Stable cycling achieved with 5C/1C charge/discharge and 90% DoD cycling. An estimated 900 cycles were executed with 80% capacity retention.

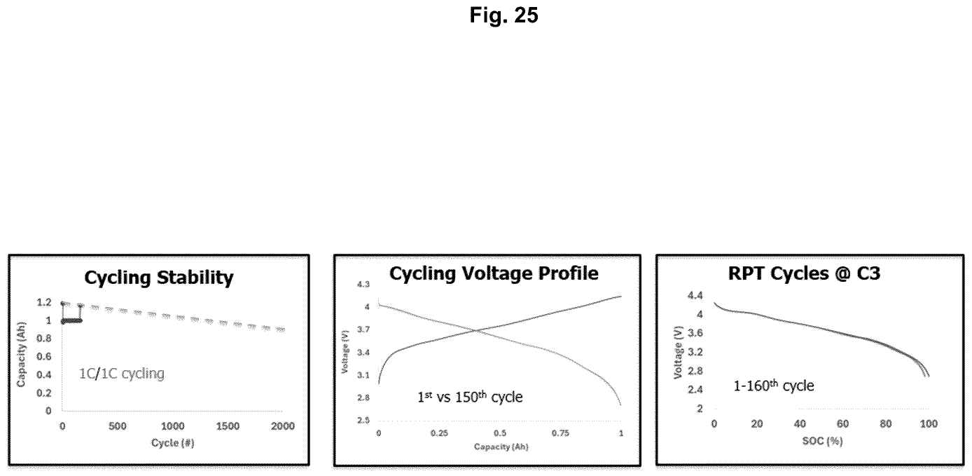

FIG. 25 is a graphical representation of voltage curves and cycling stability curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. The electrolyte showed good cycling performance without a pressure constraint at 1C/1C charge/discharge. Negligible polarization was observed in the initial 160 cycles. An estimated 1,900 cycles were executed with 80% capacity retention.

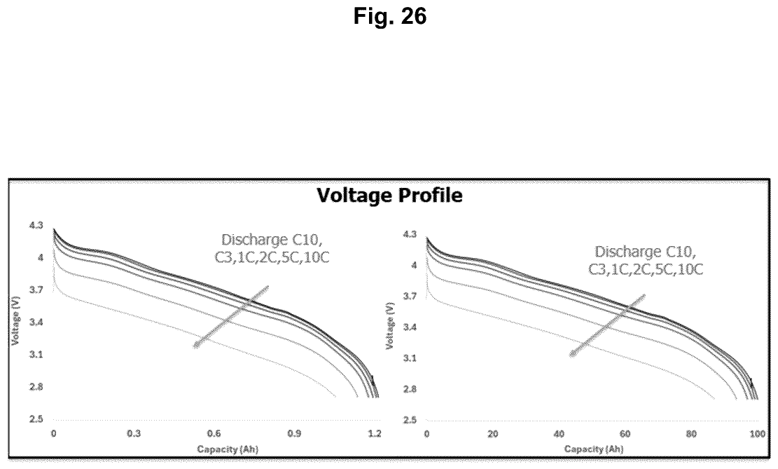

FIG. 26 is a graphical representation of voltage curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. As shown, the electrochemical cell retained more than 87% capacity and 77% energy at a 10C discharge rate. The electrochemical cell retained more than 94% capacity and 88% energy at a 5C discharge rate.

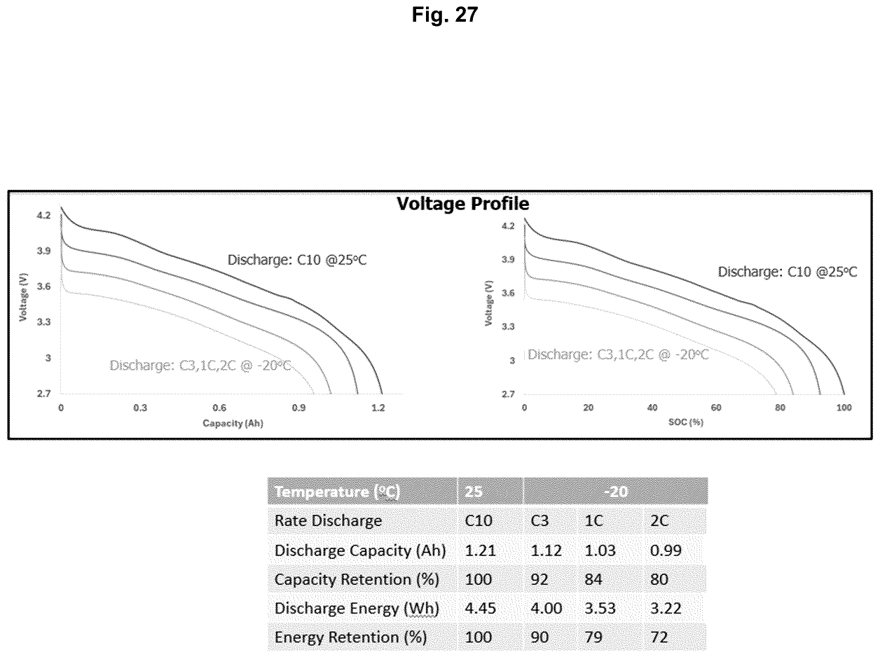

FIG. 27 is a graphical representation of voltage curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. and −20° C. As shown, the electrochemical cell retained 90% of its capacity at C3 discharge at −20° C.

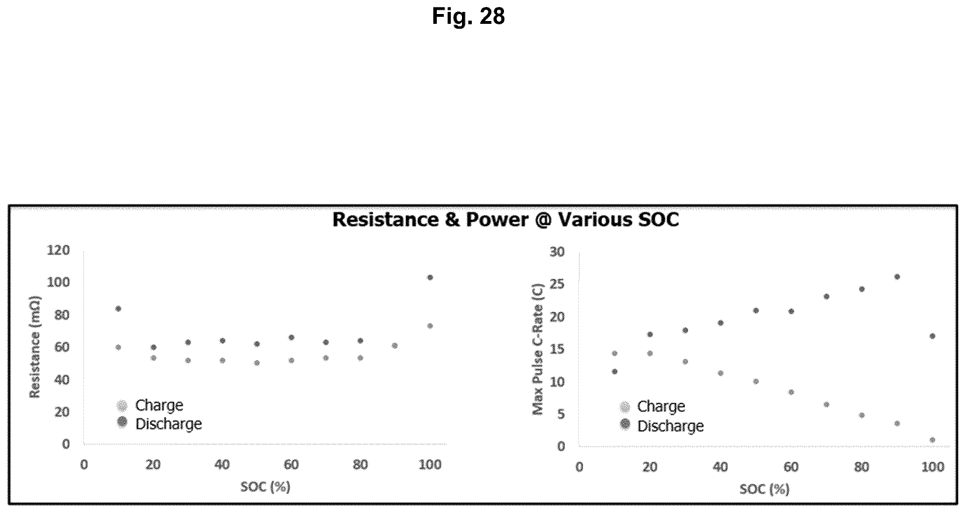

FIG. 28 is a graphical representation of resistance curves and max pulse C-rate curves of electrochemical cells including electrolytes described herein. As shown, a Si-Gr/NMC811 cell was used, having a dual-salt electrolyte with LiPF₆ and LiFSI in a fluoroether and additional solvents. Cycling was done at 25° C. The electrolyte maintains a stable resistance charge/discharge from 20-90% SOC. Charge pulses of greater than 10C were kept above 50% SOC with up to 15C maximum pulse charge. A Maximum 25C discharge pulse was achieved at 90% SOC with a minimum 10C charge pulse charge acceptance greater than 10% SOC.

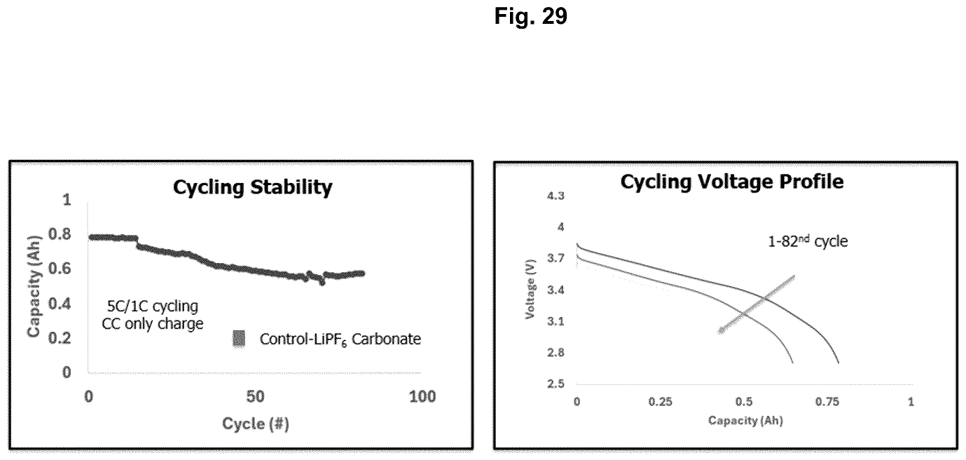

FIG. 29 is a graphical representation of cycling stability and cycling voltage profile curves of electrochemical cells including a conventional electrolyte. As shown, a Si-Gr/NMC811 cell was used. The electrolyte included 1.4 M LiPF₆ with carbonate-based solvent. Cycling was done at 25° C. The cell with a conventional electrolyte retained about 57% capacity with a 5C charge and 1C discharge over 82 cycles. Apparent cell polarization occurs starting at the 15^{th} cycle, likely due to lithium plating during fast charge.

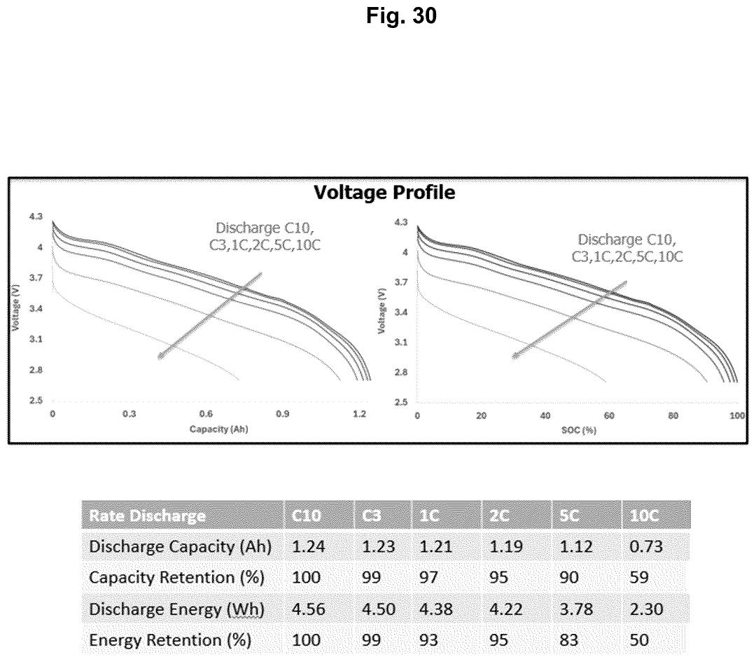

FIG. 30 is a graphical representation of voltage curves of electrochemical cells including electrolytes described herein. As shown, a Si-Gr/NMC811 cell was used, having a dual-salt electrolyte with LiPF₆ and LiFSI in a fluoroether and additional solvents. The electrolyte included 1.4 M LiPF₆ with carbonate-based solvent. Cycling was done at 25° C. As shown, the electrochemical cell retains 50% energy at 10C discharge.

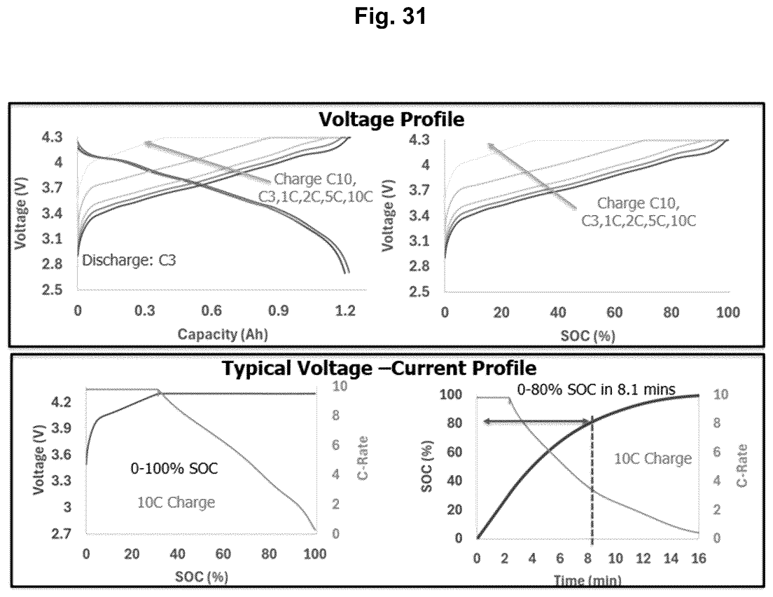

FIG. 31 is a graphical representation of cycling stability and cycling voltage profile curves of electrochemical cells including a conventional electrolyte. As shown, a Si-Gr/NMC811 cell was used. The electrolyte included 1.4 M LiPF₆ with carbonate-based solvent. Cycling was done at 25° C. A constant current charge contributed to about 35% SOC at a 10C charge rate. The electrochemical cell charged from 0-80% SOC at a 10C charge rate.

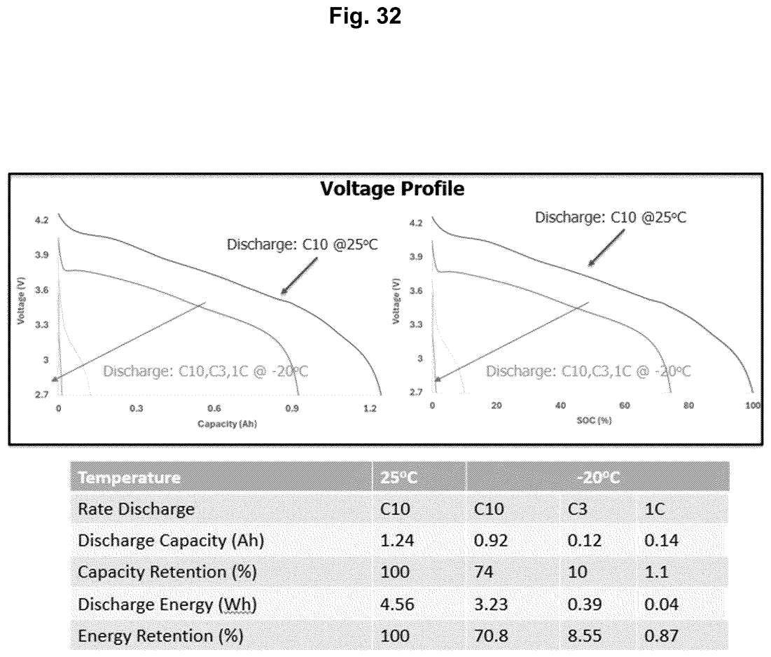

FIG. 32 is a graphical representation of cycling stability and cycling voltage profile curves of electrochemical cells including a conventional electrolyte. As shown, a Si-Gr/NMC811 cell was used. The electrolyte included 1.4 M LiPF₆ with carbonate-based solvent. Cycling was done at 25° C. The electrochemical cell retained about 74% capacity and 70% energy at a C/10 discharge rate. The electrochemical cell retained about 10% capacity and 0.4% energy at a C/3 discharge rate.

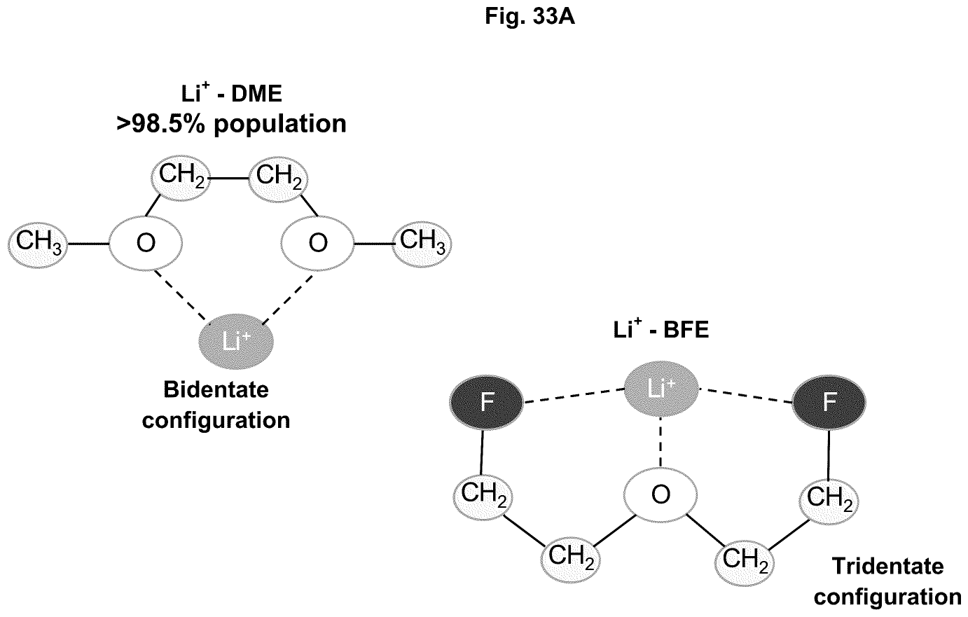

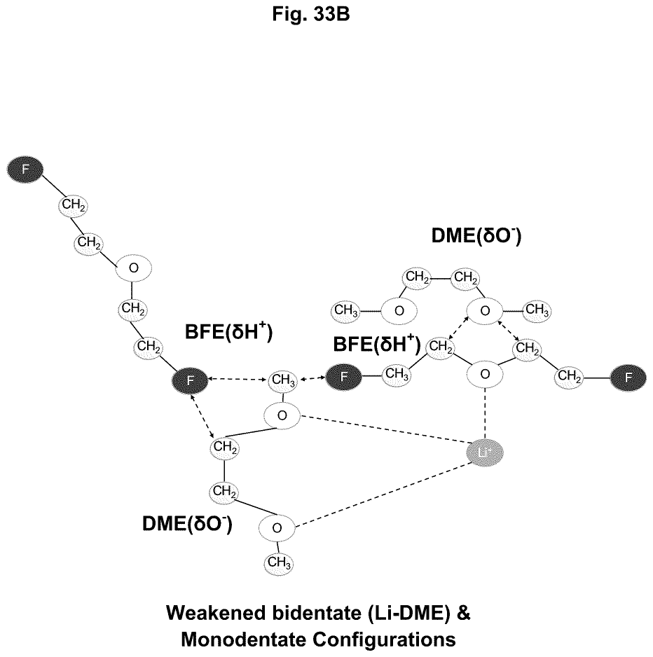

FIGS. 33A-33B show exemplary solvation structures. FIG. 33A shows Li⁺ interactions with base solvents. FIG. 33A shows Li⁺ interactions with DME in a bidentate configuration and Li⁺ interactions with BFE in a tridentate configuration via dipole forces. The electron clouds surrounding the oxygen atom as well as fluorine atoms present a strong intermolecular bonding with the Li⁺. FIG. 33B shows potential solvation structures of more complex solvent systems. As shown, the Li⁺ reacts with the oxygen and fluorine atoms of BFE and oxygen atoms of DME in a weakened bidentate and monodentate configurations. Meanwhile, atypical hydrogen bonds form between the molecules within the first and second sheath as well as between first and second solvation sheath via hydrogen-fluorine atoms and hydrogen-oxygen atoms.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A. and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A composition, comprising:
between about 2 wt % and about 15 wt % of a fluoroether;
a first electrolyte solvent;
a second electrolyte solvent different from the first electrolyte solvent;
a first salt including hexafluorophosphate ions;
a second salt different from the first salt, the first salt and the second salt collectively having a concentration between about 5 wt % and about 30 wt %;
about 0.5 wt % to about 1.5 wt % of a first additive; and
about 0.5 wt % to about 1.5 wt % of a second additive, the second additive different from the first additive.

2. The composition of claim 1, wherein an interaction energy between the fluoroether and the first electrolyte solvent is between about −10 kJ/mol to about −40 kJ/mol.

3. The composition of claim 1, further comprising lithium ions, the lithium ions form bonds with at least one of the fluoroether, the first electrolyte solvent, or the second electrolyte solvent and said bonds occupy about 5% to about 60% of a first solvation sheath.

4. The composition of claim 1, wherein the composition has a transference number that increases upon mixing between the first electrolyte solvent and the second electrolyte solvent.

5. The composition of claim 1, wherein the composition includes between about 10 wt % and about 76 wt % of the first electrolyte solvent.

6. The composition of claim 5, wherein the composition includes between about 10 wt % and about 20 wt % of the first electrolyte solvent.

7. The composition of claim 5, wherein the composition includes between about 5 wt % and about 30 wt % of the second electrolyte solvent.

8. The composition of claim 7, further comprising between about 3 wt % and about 30 wt % of a third electrolyte solvent.

9. The composition of claim 8, wherein the third electrolyte solvent includes at least one of:
1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, 7-butyrolactone, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, fluoroethylene carbonate, fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, or 3,3,4,4,5,5-hexafluorotetrahphydropyran.

10. The composition of claim 1, wherein the composition includes between about 50 wt % and about 76 wt % of the first electrolyte solvent.

11. The composition of claim 1, wherein the second salt includes bis(fluorosulfonyl)imide ions.

12. The composition of claim 1, wherein the first electrolyte solvent includes at least one of:
1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, 7-butyrolactone, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, fluoroethylene carbonate, fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, or 3,3,4,4,5,5-hexafluorotetrahphydropyran.

13. The composition of claim 1, wherein the second electrolyte solvent includes at least one of:
1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, 7-butyrolactone, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, fluoroethylene carbonate, fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, or 3,3,4,4,5,5-hexafluorotetrahphydropyran.

14. The composition of claim 1, wherein the first additive includes at least one of lithium difluorophosphate (LiPO₂F₂), vinylene carbonate, fluoroethylene carbonate, difluoroethylene carbonate, bis(2,2,2-trifluoroethyl) carbonate, 1,3,2-dioxathiolan-2,2-dioxide, propene sultone, 1,2,6-oxadithiane 2,2,6,6-tetraoxide, lithium tetrafluoro(oxalato)phosphate, lithium difluoro(dioxalato)phosphate, phenylpropenenitrile, 3-cyanothiophene, trimethylsilylcarbonitrile, butanedinitrile, hexanetricarbonitrile, bis(trimethylsilyl) malonate, 1,2,3,4-tetrakis(trimethylsilyl) 1,2,3,4-butanetetracarboxylate, 1,3-bis(trimethylsilyl) 2,2-dimethylpropanedioate, trimethylsilyl 2-methyl-2-[(trimethylsilyl)oxy]propanoate, 1,4-bis(trimethylsilyl) 2-butenedioate, tris(trimethylsilyl)amine, 1,2,3-tris(trimethylsilyl) 2-[(trimethylsilyl)oxy]-1,2,3-propanetricarboxylate, 1,2,3-tris(trimethylsilyl) 1-propene-1,2,3-tricarboxylate, trimethylsiloxyacetate, trially phosphate tris- (trimethylsilyl) phosphate (TMSP), tris(trimethylsilyl) phosphite (TMSPi), trioctyl phosphate (TOP), trimethoxy(3,3,3-trifluoropropyl)silane (TTS), pentafluorophenyltriethoxysilane (TPS), boric acid tris(trimethylsilyl) ester (TMSB), tris- (pentafluorophenyl)silane (TPFPS), 1,10-sulfonyldiimidazole (SDM), trioxane, lithium difluorophosphate, lithium difluoro oxalato borate, lithium nitrate, (pentafluorophenyl)diphenylphosphine (PFPDPP), cetyltrimethylammonium bromide (CTAB), sodium dodecyl sulfate (SDS), polyethylene-glycol (PEG-8000), and thiourea (TU), benzotriazole (BTA), thiourea (CH4N2S), sodium dodecyl benzene sulfonate (SDBS), LiTFSI, poly(vinyl alcohol) (PVA), polyethylene glycol (PEG), carboxymethyl cellulose (CMC), an organic phosphate, a phosphite, a phosphoramide, a substituted aliphatic phosphate, a substituted aryl phosphate, an unsubstituted aliphatic phosphate, an unsubstituted aryl phosphate, a phosphonate, a phosphoramide, a phosphazene, an inorganic phosphazene, an inorganic phosphazene, a polymer polyvinylidene fluoride (PVDF), poly(vinylidene fluoride-hexafluoropropylene) (PVDF-HFP), polyimide (PI), CMC, poly(acrylic acid) (PAA), PEG, polyaniline (PANI) polyacrylonitrile (PAN), poly(methyl methacrylate) (PMMA), polypropylene carbonate (PPC), polyvinylpyrrolidone (PVP), or polydimethylsiloxane (PDMS).

15. The composition of claim 14, wherein the second additive includes at least one of lithium difluorophosphate (LiPO₂F₂), vinylene carbonate, fluoroethylene carbonate, difluoroethylene carbonate, bis(2,2,2-trifluoroethyl) carbonate, 1,3,2-dioxathiolan-2,2-dioxide, propene sultone, 1,2,6-oxadithiane 2,2,6,6-tetraoxide, lithium tetrafluoro(oxalato)phosphate, lithium difluoro(dioxalato)phosphate, phenylpropenenitrile, 3-cyanothiophene, trimethylsilylcarbonitrile, butanedinitrile, hexanetricarbonitrile, bis(trimethylsilyl) malonate, 1,2,3,4-tetrakis(trimethylsilyl) 1,2,3,4-butanetetracarboxylate, 1,3-bis(trimethylsilyl) 2,2-dimethylpropanedioate, trimethylsilyl 2-methyl-2-[(trimethylsilyl)oxy]propanoate, 1,4-bis(trimethylsilyl) 2-butenedioate, tris(trimethylsilyl)amine, 1,2,3-tris(trimethylsilyl) 2-[(trimethylsilyl)oxy]-1,2,3-propanetricarboxylate, 1,2,3-tris(trimethylsilyl) 1-propene-1,2,3-tricarboxylate, trimethylsiloxyacetate, trially phosphate tris- (trimethylsilyl) phosphate (TMSP), tris(trimethylsilyl) phosphite (TMSPi), trioctyl phosphate (TOP), trimethoxy(3,3,3-trifluoropropyl)silane (TTS), pentafluorophenyltriethoxysilane (TPS), boric acid tris(trimethylsilyl) ester (TMSB), tris- (pentafluorophenyl)silane (TPFPS), 1,10-sulfonyldiimidazole (SDM), trioxane, lithium difluorophosphate, lithium difluoro oxalato borate, lithium nitrate, (pentafluorophenyl)diphenylphosphine (PFPDPP), cetyltrimethylammonium bromide (CTAB), sodium dodecyl sulfate (SDS), polyethylene-glycol (PEG-8000), and thiourea (TU), benzotriazole (BTA), thiourea (CH4N2S), sodium dodecyl benzene sulfonate (SDBS), LiTFSI, poly(vinyl alcohol) (PVA), polyethylene glycol (PEG), carboxymethyl cellulose (CMC), an organic phosphate, a phosphite, a phosphoramide, a substituted aliphatic phosphate, a substituted aryl phosphate, an unsubstituted aliphatic phosphate, an unsubstituted aryl phosphate, a phosphonate, a phosphoramide, a phosphazene, an inorganic phosphazene, an inorganic phosphazene, a polymer, polyvinylidene fluoride (PVDF), poly(vinylidene fluoride-hexafluoropropylene) (PVDF-HFP), polyimide (PI), CMC, poly(acrylic acid) (PAA), PEG, polyaniline (PANI) polyacrylonitrile (PAN), poly(methyl methacrylate) (PMMA), polypropylene carbonate (PPC), polyvinylpyrrolidone (PVP), or polydimethylsiloxane (PDMS).

16. The composition of claim 1, further comprising between about 0.5 wt % and about 1.5 wt % of a third additive, the third additive including at least one of vinylene carbonate, fluoroethylene carbonate, difluoroethylene carbonate, bis(2,2,2-trifluoroethyl) carbonate, 1,3,2-dioxathiolan-2,2-dioxide, propene sultone, 1,2,6-oxadithiane 2,2,6,6-tetraoxide, lithium tetrafluoro(oxalato)phosphate, lithium difluoro(dioxalato)phosphate, phenylpropenenitrile, 3-cyanothiophene, trimethylsilylcarbonitrile, butanedinitrile, hexanetricarbonitrile, bis(trimethylsilyl) malonate, 1,2,3,4-tetrakis(trimethylsilyl) 1,2,3,4-butanetetracarboxylate, 1,3-bis(trimethylsilyl) 2,2-dimethylpropanedioate, trimethylsilyl 2-methyl-2-[(trimethylsilyl)oxy]propanoate, 1,4-bis(trimethylsilyl) 2-butenedioate, tris(trimethylsilyl)amine, 1,2,3-tris(trimethylsilyl) 2-[(trimethylsilyl)oxy]-1,2,3-propanetricarboxylate, 1,2,3-tris(trimethylsilyl) 1-propene-1,2,3-tricarboxylate, trimethylsiloxyacetate, trially phosphate tris- (trimethylsilyl) phosphate (TMSP), tris(trimethylsilyl) phosphite (TMSPi), trioctyl phosphate (TOP), trimethoxy(3,3,3-trifluoropropyl)silane (TTS), pentafluorophenyltriethoxysilane (TPS), boric acid tris(trimethylsilyl) ester (TMSB), tris- (pentafluorophenyl)silane (TPFPS), 1,10-sulfonyldiimidazole (SDM), trioxane, lithium difluorophosphate, lithium difluoro oxalato borate, lithium nitrate, (pentafluorophenyl)diphenylphosphine (PFPDPP), cetyltrimethylammonium bromide (CTAB), sodium dodecyl sulfate (SDS), polyethylene-glycol (PEG-8000), and thiourea (TU), benzotriazole (BTA), thiourea (CH4N2S), sodium dodecyl benzene sulfonate (SDBS), LiTFSI, poly(vinyl alcohol) (PVA), polyethylene glycol (PEG), carboxymethyl cellulose (CMC), an organic phosphate, a phosphite, a phosphoramide, a substituted aliphatic phosphate, a substituted aryl phosphate, an unsubstituted aliphatic phosphate, an unsubstituted aryl phosphate, a phosphonate, a phosphoramide, a phosphazene, an inorganic phosphazene, an inorganic phosphazene, a polymer, polyvinylidene fluoride (PVDF), poly(vinylidene fluoride-hexafluoropropylene) (PVDF-HFP), polyimide (PI), CMC, poly(acrylic acid) (PAA), PEG, polyaniline (PANI) polyacrylonitrile (PAN), poly(methyl methacrylate) (PMMA), polypropylene carbonate (PPC), polyvinylpyrrolidone (PVP), or polydimethylsiloxane (PDMS).

17. The composition of claim 1, wherein the fluoroether has the following molecular structure: 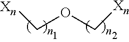
where n₁ and n₂ can each have values between 1 and 5, X=F, Cl, Br, or I, n=1, 2, or 3 per molecule.

18. The composition of claim 1, wherein the fluoroether has the following molecular structure: 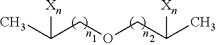
where n₁ and n₂ can each have values between 1 and 5, X=F, Cl, Br, or I, n=1 or 2 per molecule.

19. An electrochemical cell, comprising:
an anode;
a cathode;
a separator disposed between the anode and the cathode; and
a liquid electrolyte, the liquid electrolyte comprising:
a fluoroether;
a first electrolyte solvent;
a second electrolyte solvent different from the first electrolyte solvent;
a first salt including hexafluorophosphate ions;
a second salt different from the first salt, the first salt and the second salt collectively having a concentration between about 5 wt % and about 30 wt %;
about 0.5 wt % to about 1.5 wt % of a first additive; and
about 0.5 wt % to about 1.5 wt % of a second additive, the second additive different from the first additive.

20. The electrochemical cell of claim 19, wherein the anode includes at least one of silicon, tin, antimony, lead, silicon oxide, SiOₓ (where x=0.5, 1 or 2), graphite, carbon nanotubes (CNT), graphene, a silicon/graphite composite, a SiOₓ/graphite composite (where x=0.5, 1 or 2), a silicon/graphite/lithium composite, or a SiOₓ/graphite/lithium composite (where x=0.5, 1 or 2), tin oxide, antimonic oxide, lead oxide, a tin/graphite composite, a tin oxide/graphite composite, a tin/graphite/lithium composite, a tin oxide/graphite/lithium composite, an antimony/graphite composite, an antimonic oxide/graphite composite, an antimony/graphite/lithium composite, an antimonic oxide/graphite/lithium composite, a lead/graphite composite, a lead oxide/graphite composite, a lead/graphite/lithium composite, a lead oxide/graphite/lithium composite, a silicon/CNT composite, a SiO/CNT composite (where x=0.5, 1, or 2), a silicon/CNT/lithium composite, or a SiOₓ/CNT/lithium composite (where x=0.5, 1, or 2), a tin/CNT composite, a tin oxide/CNT composite, a tin/CNT/lithium composite, a tin oxide/CNT/lithium composite, an antimony/CNT composite, an antimonic oxide/CNT composite, an antimony/CNT/lithium composite, an antimonic oxide/CNT/lithium composite, a lead/CNT composite, a lead oxide/CNT composite, a lead/CNT/lithium composite, a lead oxide/CNT/lithium composite, a silicon/graphene composite, a SiOₓ/graphene composite (where x=0.5, 1 or 2), a silicon/graphene/lithium composite, or a SiOₓ/graphene/lithium composite (where x=0.5, 1 or 2), a tin/graphene composite, a tin oxide/graphene composite, a tin/graphene/lithium composite, a tin oxide/graphene/lithium composite, an antimony/graphene composite, an antimonic oxide/graphene composite, an antimony/graphene/lithium composite, an antimonic oxide/graphene/lithium composite, a lead/graphene composite, a lead oxide/graphene composite, a lead/graphene/lithium composite, lead oxide/graphene/lithium composite, a metal silicide, nickel silicide, cobalt silicide, copper silicide, silver silicide, chromium silicide, titanium silicide, aluminum silicide, zinc silicide, iron silicide, a non-silicide electrode, crystalline silicon, amorphous silicon, silicon oxides, silicon oxy-nitrides, tin-containing material, a germanium-containing material, doped non-silicide with dopants from group 3 and/or group 5 elements, a metal, a metal oxide, a metal sulfide, a metal phosphide that is active towards alloying reaction and/or conversion reaction with Li, Na, and/or K Sn, Sb, Ag, Bi, Pb, Se, S, Al, In, Te, Au, Ti, Fe, Co, Ni, Cu, Zn, V, Cr, Ca, Ge, or W.

21. The electrochemical cell of claim 19, wherein the cathode includes at least one of lithium nickel manganese cobalt oxide (NMC), an NMC derivative, lithium iron phosphate (LFP), an LFP derivative, a conversion-based anode, sulfur, a sulfur derivative, a metal fluoride, CuF₂, FeF₂, Fe₂F₃, or LiO₂.

22. The electrochemical cell of claim 19, further comprising a solid-state electrolyte.

23. The electrochemical cell of claim 22, wherein the solid-state electrolyte includes at least one of a Lithium Super Ionic Conductor (LISICON) structure, a glass structure such as La_{0.51}Ti_{0.34}TiO_{2.94}, Li_{1.3}Al_{0.3}Ti_{1.7}(PO₄)₃ (LATP), Li_{1.3}Al_{0.3}Ti_{1.7}(PO₄)₃, Li_{1.4}Al_{0.4}Ti_{1.6}(PO₄)₃, Li₇La₃Zr₂O₁₂, Li_{6.66}La₃Zr_{1.6} Ta_{0.4}O_{12.9} (LLZO), 50Li₄SiO₄·50Li₃BO₃, Li_{2.9}PO_{3.3}N_{0.46} (lithium phosphorousoxynitride, LiPON), Li_{3.6}Si_{0.6}P_{0.4}O₄, Li₃BN₂, Li₃BO₃—Li₂SO₄, Li₃BO₃—Li₂SO₄—Li₂CO₃ (LIBSCO, pseudoternary system), and/or sulfide contained solid-state electrolyte including a thio-LISICON structure, a glassy structure and/or a glass-ceramic structure such as Li_{1.07}Al_{0.69}Ti_{1.46}(PO₄)₃, Li_{1.5}Al_{0.5}Ge_{1.5}(PO₄)₃, Li₁₀GeP₂S₁₂ (LGPS), 30Li₂S·26B₂S₃·44LiI, 63Li₂S·36SiS₂·1Li₃PO₄, 57Li₂S·38SiS₂·5Li₄SiO₄, 70Li₂S·30P₂S₅, 50Li₂S·50GeS₂, Li₇P₃S₁₁, Li_{3.25}P_{0.95}S₄, and Li_{9.54}Si_{1.74}P_{1.44}S_{11.7}C_{10.3}, and/or closo-type complex hydride solid-state electrolyte such as LiBH₄—LiI, LiBH₄—LiNH₂, LiBH₄—P₂S₅, Li(CBₓHₓ₊₁)—LiI (where x is an integer) like Li(CB₉H₁₀)—LiI; phosphate sulfide-based electrolytes, including lithium phosphorus sulfide (LPS), Li₁₀GeP₂S₁₂ (LGPS), lithium tin phosphorus sulfide (LSPS), and/or Li_{5.5}PS_{4.5}Cl_{1.5} (LPSCI) and/or lithium argyrodite Li₆PS₅X (X=Cl, Br) or halide electrolytes Li₃₋ₓM₁₋ₓX₆ (M=Y, Er, In, Yb, Ho, X=Cl, Br, I, F).

24. The electrochemical cell of claim 19, wherein the fluoroether has the following molecular structure: 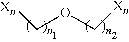
where n₁ and n₂ can each have values between 1 and 5, X=F, Cl, Br, or I, n=1, 2, or 3 per molecule.

25. The electrochemical cell of claim 19, wherein the fluoroether has the following molecular structure: 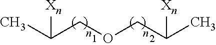
where n₁ and n₂ can each have values between 1 and 5, X=F, Cl, Br, or I, n=1 or 2 per molecule.

26. A composition comprising:
about 10 wt % to about 30 wt % of a salt including hexafluorophosphate ions,
about 40 wt % to about 60 wt % of a first electrolyte solvent, the first electrolyte solvent including methyl acetate;
about 5 wt % to about 10 wt % of a second electrolyte solvent, the second electrolyte solvent different from the first electrolyte solvent;
about 5 wt % to about 10 wt % of a third electrolyte solvent, the third electrolyte solvent different from the first electrolyte solvent and the second electrolyte solvent.

27. The composition of claim 26, wherein the second electrolyte solvent includes at least one of 1-ethoxy-2-methoxy ethane, 1-methoxy-2-propoxy ethane, 1,1-dimethoxy methane, 1,1-diiethoxy methane, 1,3-dimethoxy propane, 1,4-dimethoxy butane, 4-diethooxy methane, fluorinated dimethoxy butane, fluorinated 1-methoxy-2-propoxy ethane, 1,1,1-trifluoro-2,3-dimethoxy propane, 1,2-dimethoxy propane, 2,2-difluoroethyl acetate, 2,2,2-trifluoroethyl acetate, difluoroacetate, ethyl 2,2-difluoroacetate, ethyl difluoroacetate, methyl difluoroacetate, hexafluoroisopropyl acetate, methyl 2,2-difluoro-2-(fluorosulfonyl)acetate, methyl 2,3,3,3-tetrafluoro propionate methyl 2,3,3,3-tetrafluoro propionate, 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, 7-butyrolactone, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, ethyl acetate, ethyl butyrate, methyl acetate, methylbutyrate, methyl propionate, methyl pentafluoropropionate, propyl acetate, 2,2,2-trifluoroethyl acetate, 2,2,2-trifluoroethyl butyrate, dimethyl sulfoxide, ethyl vinyl sulfone, tetramethylene sulfone, ethyl methyl sulfone, ethylene carbonate, vinylene carbonate, fluoroethylene carbonate, fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanesulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, or 3,3,4,4,5,5-hexafluorotetrahphydropyran.

28. The composition of claim 26, wherein the third electrolyte solvent includes a fluoroether.

29. The composition of claim 28, wherein the fluoroether has the following molecular structure 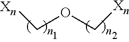
where n₁ and n₂ can each have values between 1 and 5, X=F, Cl, Br, or I, n=1, 2, or 3 per molecule.

30. The composition of claim 28, wherein the fluoroether has the following molecular structure: 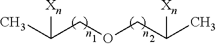
where n₁ and n₂ can each have values between 1 and 5, X=F, Cl, Br, or I, n=1 or 2 per molecule.
